(19) United States
(12) Patent Application Publication
(10) Pub. No.: US 2023/0308811 A1
(43) Pub. Date: Sep. 28, 2023

(54) OPTICAL MICROPHONE AND INFORMATION PROCESSING APPARATUS

(71) Applicant: SONY GROUP CORPORATION, TOKYO (JP)

(72) Inventors: OSAMU NAKAMURA, TOKYO (JP); KOHEI ASADA, TOKYO (JP)

(21) Appl. No.: 18/003,734

(22) PCT Filed: Jun. 22, 2021
(86) PCT No.: PCT/JP2021/023502

§ 371 Date: Dec. 29, 2022

(30) Foreign Application Priority Data
Jul. 6, 2020 (JP) 2020-116524

(51) Int. Cl. H04R 23/00; H04R 1/04; H04R 29/00; H04R 3/04; G02B 21/06

(52) U.S. Cl. CPC H04R 23/008; G02B 21/06; H04R 1/04; H04R 3/04; H04R 29/004

(57) ABSTRACT

An optical microphone includes a housing, a diaphragm provided in the housing, a first light source provided within the housing, a first light receiving element provided within the housing, a detection unit that detects an output of the first light receiving element, and a control unit that switches a control mode from a first control mode to a second control mode according to a determination result of an abnormal state by the detection unit.

### FIELD

The present disclosure relates to an optical microphone and an information processing apparatus.

### BACKGROUND

Optical microphones that convert sound waves into electrical signals using light have been developed. Some microphones using light detect vibration of a diaphragm using light. An optical microphone requiring a diaphragm is expected to have a higher signal to noise ratio (SNR) than an electret capacitor type which is currently most widely used. In the electret capacitor type, it is necessary to dispose a fixed electrode immediately near the diaphragm, and to form a capacitor between the diaphragm and the fixed electrode. The presence of a structure near the diaphragm inhibits vibration of the diaphragm and generates noise. In the optical microphone, a light source and a light receiving element are disposed at a distance that does not inhibit the vibration of the diaphragm, and the vibration of the diaphragm can be detected by a change in light and converted into an electric signal.

### CITATION LIST

### Patent Literature

Patent Literature 1: JP 2017-92729 A

### Non Patent Literature

Non Patent Literature 1: “Safety Standards for Laser Products” (JIS C 6802, IEC 60825-1)

### SUMMARY

### Technical Problem

A laser is preferably used as a light source of the optical microphone. The laser has high coherence. That is, the laser has high coherence and high rectilinearity. By using the laser, for example, the vibration of the diaphragm can be detected with high accuracy using interference of light.

However, since the laser has high coherence, there is a concern about an influence on a human body, particularly an eye portion. In Non Patent Literature 1, “Safety Standards of Laser Products” (JIS C 6802, IEC 60825-1), lasers are classified by using an acceccible emission limit (AEL). The class classification is classes 1 to 4. Class 1 is the safest and class 4 is the most risky. In the case of an optical microphone, even if light is not radiated to the outside of the microphone during normal use, if the diaphragm is damaged, the light may be radiated to the outside from an opening. For example, the diaphragm may be damaged when a strong impact such as dropping on the floor is applied. Microphones are often oriented toward the face of a human being for the purpose of collecting sound. As a result, a level of laser that affects the human body may be emitted from the opening where the diaphragm is damaged.

Therefore, the present disclosure proposes an information processing apparatus capable of taking safety measures for a user in a case where an unintended opening is generated or even in a case where an intended opening is provided.

### Solution to Problem

In order to solve the above problem, an optical microphone according to one embodiment of the present disclosure includes: a housing; a diaphragm provided in the housing; a first light source provided within the housing; a first light receiving element provided within the housing; a detection unit that detects an output of the first light receiving element; and a control unit that switches a control mode from a first control mode to a second control mode according to a determination result of an abnormal state by the detection unit.

### BRIEF DESCRIPTION OF DRAWINGS

FIG. 1 is a schematic diagram illustrating a configuration of an optical microphone according to an embodiment of the present disclosure.

FIG. 2 is a schematic diagram illustrating a detection method of the optical microphone according to the embodiment of the present disclosure.

FIG. 3 is a schematic diagram illustrating another example of the detection method of the optical microphone according to the embodiment of the present disclosure.

FIG. 4 is a schematic diagram illustrating another example of the detection method of the optical microphone according to the embodiment of the present disclosure.

FIG. 5 is a diagram illustrating an example of a detection principle of the optical microphone according to the embodiment of the present disclosure.

FIG. 6 is a schematic diagram illustrating a configuration of an optical microphone according to a first embodiment of the present disclosure.

FIG. 7 is a flowchart illustrating an operation of the optical microphone according to the first embodiment of the present disclosure.

FIG. 8 is a diagram illustrating an example of a detection principle of the optical microphone according to the first embodiment of the present disclosure.

FIG. 9 is a diagram illustrating an example of the detection principle of the optical microphone according to the first embodiment of the present disclosure.

FIG. 10 is a diagram illustrating another example of the detection principle of the optical microphone according to the first embodiment of the present disclosure.

FIG. 11 is a schematic diagram illustrating another configuration of the optical microphone according to the first embodiment of the present disclosure.

FIG. 12 is an explanatory diagram of another configuration of FIG. 11.

FIG. 13 is a schematic diagram illustrating another configuration of the optical microphone according to the first embodiment of the present disclosure.

FIG. 14 is an explanatory diagram of another configuration of FIG. 13.

FIG. 15 is a schematic diagram illustrating an operation of another configuration of the optical microphone according to the first embodiment of the present disclosure.

FIG. 16 is a schematic diagram illustrating an operation of another configuration of the optical microphone according to the first embodiment of the present disclosure.

FIG. 17 is a schematic diagram illustrating another configuration of the optical microphone according to the first embodiment of the present disclosure.

FIG. 18 is a flowchart illustrating an operation of another configuration of FIG. 17.

FIG. 19 is a schematic diagram illustrating a configuration of an information processing apparatus according to an embodiment of the present disclosure.

FIG. 20 is a schematic diagram illustrating another configuration of the information processing apparatus according to the embodiment of the present disclosure.

FIG. 21 is a schematic diagram illustrating another configuration of the information processing apparatus according to the embodiment of the present disclosure.

FIG. 22 is a schematic diagram illustrating an application example of the optical microphone according to the first embodiment of the present disclosure.

FIG. 23 is a schematic diagram illustrating the application example of the optical microphone according to the first embodiment of the present disclosure.

FIG. 24 is a schematic diagram illustrating the application example of the optical microphone according to the first embodiment of the present disclosure.

FIG. 25 is a schematic diagram illustrating the application example of the optical microphone according to the first embodiment of the present disclosure.

FIG. 26 is a schematic diagram illustrating a configuration of an optical microphone according to a second embodiment of the present disclosure.

FIG. 27 is a schematic diagram illustrating the configuration of the optical microphone according to the second embodiment of the present disclosure.

FIG. 28 is a schematic diagram illustrating another configuration of the optical microphone according to the second embodiment of the present disclosure.

FIG. 29 is a schematic diagram illustrating another configuration of the optical microphone according to the second embodiment of the present disclosure.

FIG. 30 is a schematic diagram illustrating another configuration of the optical microphone according to the second embodiment of the present disclosure.

FIG. 31 is a schematic diagram illustrating another configuration of the optical microphone according to the second embodiment of the present disclosure.

FIG. 32 is a schematic diagram illustrating another configuration of the optical microphone according to the second embodiment of the present disclosure.

FIG. 33 is a schematic diagram illustrating another configuration of the optical microphone according to the second embodiment of the present disclosure.

FIG. 34 is a schematic diagram illustrating another configuration of the optical microphone according to the second embodiment of the present disclosure.

FIG. 35 is a schematic diagram illustrating another configuration of the optical microphone according to the second embodiment of the present disclosure.

FIG. 36 is a schematic diagram illustrating another configuration of the optical microphone according to the second embodiment of the present disclosure.

FIG. 37 is a schematic diagram illustrating another configuration of the optical microphone according to the second embodiment of the present disclosure.

FIG. 38 is a schematic diagram illustrating another configuration of the optical microphone according to the second embodiment of the present disclosure.

FIG. 39 is a schematic diagram illustrating another configuration of the optical microphone according to the second embodiment of the present disclosure.

FIG. 40 is a schematic diagram illustrating another configuration of the optical microphone according to the second embodiment of the present disclosure.

FIG. 41 is a schematic diagram illustrating another configuration of the optical microphone according to the second embodiment of the present disclosure.

FIG. 42 is a schematic diagram illustrating another configuration of the optical microphone according to the second embodiment of the present disclosure.

FIG. 43 is a schematic diagram illustrating another configuration of the optical microphone according to the second embodiment of the present disclosure.

FIG. 44 is a schematic diagram illustrating another configuration of the optical microphone according to the second embodiment of the present disclosure.

FIG. 45 is a schematic diagram illustrating another configuration of the optical microphone according to the second embodiment of the present disclosure.

### DESCRIPTION OF EMBODIMENTS

Hereinafter, embodiments of the present disclosure will be described in detail with reference to the drawings. Note that, in each of the following embodiments, the same parts are denoted by the same signs, and redundant description will be omitted.

Note that the description will be given in the following order.
0. Introduction
1. Schematic configuration of optical microphone
2. Detection method of optical microphone
3. Vibration detection principle of optical microphone
4. First embodiment
4.1 Configuration of optical microphone of first embodiment
4.2 Operation of optical microphone of first embodiment
4.3 Abnormality detection principle
4.4 Modification example of light receiving element
4.5 Another configuration of optical microphone of first embodiment
4.6 Another configuration of optical microphone of first embodiment
4.7 Another configuration of optical microphone of first embodiment
4.8 Another configuration of optical microphone of first embodiment
4.9 Another configuration of optical microphone of first embodiment
4.10 Configuration of information processing apparatus of first embodiment
4.11 Another configuration of information processing apparatus of first embodiment
4.12 Application example
4.13 Effects of first embodiment
5. Second embodiment
5.1 Regarding optical microphone of second embodiment
5.2 Configuration of optical microphone of second embodiment
5.3 Working of optical microphone 1400
5.4 Another configuration of optical microphone of second embodiment
5.5 Working of optical microphone 1500
5.6 Another configuration of optical microphone of second embodiment
5.7 Working of optical microphone 1600
5.8 Another configuration of optical microphone of second embodiment
5.9 Working of optical microphone 1700
5.10 Another configuration of optical microphone of second embodiment
5.11 Working of optical microphone 1800
5.12 Another configuration of optical microphone of second embodiment
5.13 Working of optical microphone 1900
5.14 Another configuration of optical microphone of second embodiment
5.15 Working of optical microphone 2000
5.16 Another configuration of optical microphone of second embodiment
5.17 Another configuration of optical microphone of second embodiment
5.18 Working of optical microphone 2200
5.19 Another configuration of optical microphone of second embodiment
5.20 Application example
5.21 Effects of second embodiment

### 0. Introduction

As described above, it is preferable to use a laser as a light source of the optical microphone. The laser has high coherence. That is, the laser has high coherence and high rectilinearity. By using the laser, for example, the vibration of the diaphragm can be detected with high accuracy using interference of light.

However, since the laser has high coherence, there is a concern about an influence on a human body, particularly an eye portion. In Non Patent Literature 1, “Safety Standards of Laser Products” (JIS C 6802, IEC 60825-1), lasers are classified by using an acceccible emission limit (AEL). The class classification is classes 1 to 4. Class 1 is the safest and class 4 is the most risky. In the case of an optical microphone, even if light is not radiated to the outside of the microphone during normal use, if the diaphragm is damaged, the light may be radiated to the outside from an opening. For example, the diaphragm may be damaged when a strong impact such as dropping on the floor is applied. Microphones are often oriented toward the face of a human being for the purpose of collecting sound. As a result, a level of laser that affects the human body may be emitted from the opening where the diaphragm is damaged.

On the other hand, in an optical microphone aiming at a high SNR, there is a demand for using strong light for a light source. If strong light leaks to the outside of the optical microphone, there is a concern about an influence on a human body. Furthermore, in order to improve SNR or the like, there is a demand for an optical microphone to use infrared light having a longer wavelength than visible light or ultraviolet light having a shorter wavelength as a light source. In the case of ultraviolet light or infrared light, there is a possibility that the user continues to be exposed without noticing the leakage.

Furthermore, when the diaphragm is damaged and an opening is generated, there is another problem. The light receiving element may receive light (also referred to as external light) different from the light source through the opening where the diaphragm is damaged. When the light receiving element receives external light from the opening in which the diaphragm is damaged, the light receiving element receives the external light in addition to the light of the light source, and the light intensity received by the light receiving element changes. The optical microphone outputs a sound wave as an electric signal, that is, an audio signal. In a case where a system to which the optical microphone is connected is connected to a transducer such as a speaker via an amplifier, an output audio signal of the optical microphone is amplified by a change in light intensity received by the light receiving element and reproduced from the speaker. In a case where an audio signal of an unintended maximum scale is output from the optical microphone, the explosive sound is reproduced from the speaker depending on an amplification degree of the amplifier, and there is a possibility that the user’s hearing is affected.

Meanwhile, an optical microphone may be provided with an opening called a ventilation hole. The purpose of the ventilation hole is to alleviate a pressure difference in a space (cavity) before and after the diaphragm.

Furthermore, in the case of a directional microphone, the optical microphone is provided with a sound collection opening for taking in a sound wave from the other side of the diaphragm in addition to the one side.

However, in the optical microphone having the opening, the light receiving element may receive light (also referred to as external light) different from the light source through the opening. For example, when the light receiving element receives external light in addition to the light of the light source, the light intensity received by the light receiving element changes. In this case, as described above, an unintended scale audio signal is output to the system to which the optical microphone is connected, which may affect the hearing of the user.

As described above, when the external light enters the optical microphone, there is a possibility that an operation as the optical microphone is affected, and thus, a means for preventing the entry of the external light is necessary. For example, Patent Literature 1 discloses, as measures against the external light, a method of using a filter that allows sound waves to pass and does not allow the external light to pass, and a method of using a light source other than visible light as a light source. However, in the former, the sound wave has to pass through the filter, and the influence on the sound quality cannot be avoided. In the latter, even if the light source is ultraviolet rays or infrared rays, when various use environments are assumed, light having such a wavelength can also exist as external light.

Furthermore, in an optical microphone having an opening, light from a light source may be reflected by a light receiving element, and reflected light reflected by the light receiving element may leak from the opening to the outside. In this case, as described above, when the light source is a laser light source, there is a possibility that a laser is emitted from the optical microphone to the outside.

Therefore, in the following embodiment, an information processing apparatus capable of taking a safety measure for the user even in a case where an unintended opening is generated or even in a case where an intended opening is provided is proposed. Furthermore, the present disclosure proposes an optical microphone capable of suppressing leakage of light from a light source to the outside and suppressing influence of external light on an output operation even in a case where an unintended opening is generated or an intended opening is provided.

### 1. Schematic Configuration of Optical Microphone

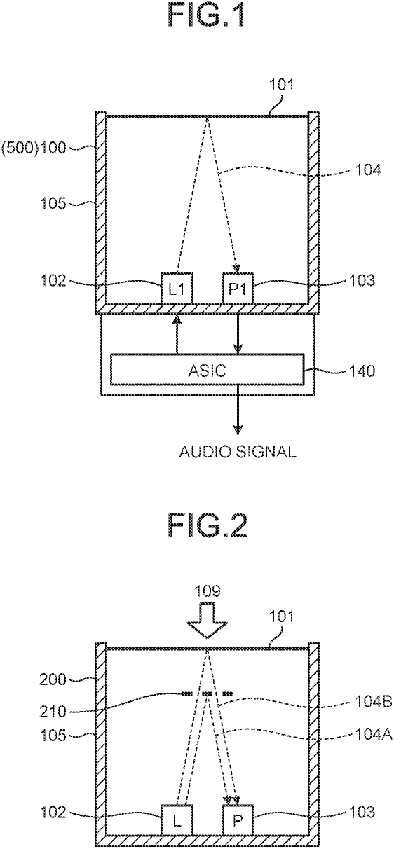

FIG. 1 is a schematic diagram illustrating a configuration of an optical microphone according to an embodiment of the present disclosure. An optical microphone 100 includes a housing 105, a diaphragm 101, a light source (first light source) 102, a light receiving element (first light receiving element) 103 (photo detector), and an application specific integrated circuit (ASIC) 140. The housing 105 supports the diaphragm 101. Furthermore, in the housing 105, the light source 102 is disposed such that light 104 emitted from the light source 102 impinges on the diaphragm 101, and the light receiving element 103 is disposed such that the light 104 reflected by the diaphragm 101 is incident on the light receiving element 103. In the present embodiment, the light source 102 and the light receiving element 103 are disposed inside a space formed by the housing 105 and the diaphragm 101. In order to efficiently reflect the light 104 emitted from the light source 102, the diaphragm 101 has a surface facing the light source 102 and the light receiving element 103 as a reflective surface. The light source 102 is preferably a laser and may be a light emitting diode (LED). In a case where the light source 102 is a laser, in particular, a semiconductor laser has characteristics of being compact, highly efficient, high output, high coherence, and capable of being directly modulated. In a vertical cavity surface emitting laser (VCSEL), since a resonator is formed in a direction perpendicular to a substrate surface of the semiconductor, a laser beam is emitted perpendicularly to the substrate surface, and the VCSEL will be smaller and more stable. The light receiving element 103 has a wavelength range including at least a wavelength of the light 104 emitted by the light source 102. The ASIC 140 normally converts the output of the light receiving element 103 into an audio signal by a processing unit (not illustrated), and outputs the audio signal from the optical microphone 100. That is, in the optical microphone 100, the light 104 emitted from the light source 102 is reflected by the surface of the diaphragm 101 on a side of the light source and is incident on the light receiving element 103. The light 104 transmits vibration information of the diaphragm to the light receiving element 103 by an optical action (not illustrated). The ASIC 140 converts the vibration information of the diaphragm 101 into an output (sound output) of an audio signal by processing the output of the light receiving element 103 by a processing unit (not illustrated). Note that an element (not illustrated) for adjusting the spread of light such as a collimator may be provided on a side of a light emitting surface of the light source 102. The optical microphone 100 illustrated in FIG. 1 has a configuration in which the diaphragm 101 and the housing 105 do not have an opening through which light outside the housing 105 passes, and light outside the housing 105 is not received by the light receiving element 103 during normal use.

### 2. Detection Method of Optical Microphone

FIGS. 2 to 4 are schematic diagrams illustrating detection methods of the optical microphone according to the embodiment of the present disclosure.

An optical microphone 200 of a detection method illustrated in FIG. 2 uses interference by a diffraction grating 210. The diffraction grating 210 is disposed inside the housing 105 between the diaphragm 101, and the light source 102 and the light receiving element 103. The light emitted from the light source 102 is divided into light 104A reflected by the diffraction grating 210 and light 104B passing through the diffraction grating 210. The light 104B having passed through the diffraction grating 210 is reflected by the diaphragm 101 and passes through the diffraction grating 210 again. The light 104A, 104B in the two optical paths is incident on the light receiving element 103 while causing interference. Interference occurs depending on a distance between the diffraction grating 210 and the diaphragm 101. Since the diaphragm 101 is vibrated by a sound wave 109, the distance between the diffraction grating 210 and the diaphragm 101 is changed by the sound wave 109. Since 104A, 104B has a wavelength in a unit of nanometer (nm) to micrometer (µm), it is possible to detect vibration of the diaphragm 101 at a nanometer level or less.

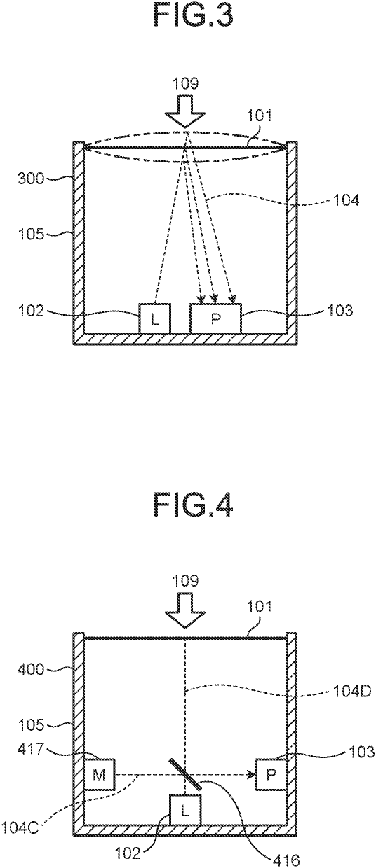

An optical microphone 300 of a detection method illustrated in FIG. 3 uses a change in a reflection angle of the light 104 reflected by the diaphragm 101. Since the diaphragm 101 vibrates as indicated by a broken line in FIG. 3 by the vibration of the sound wave 109, a reflection angle of the light 104 emitted from the light source 102 changes depending on an amplitude of the diaphragm 101 when reflected by the diaphragm 101. As the reflection angle changes, a position of the light 104 incident on the light receiving element 103 changes. As the light receiving element 103, for example, a light receiving element having a plurality of sections such as a photodiode array can be easily used. Alternatively, it is also possible to use a configuration in which a photodiode having only one section is used, and a ratio of the light 104 incident on the light receiving element 103 changes according to a change in the incident position of the light 104.

An optical microphone 400 of a detection method illustrated in FIG. 4 uses a two-optical path interference system. The optical microphone 400 includes a beam splitter 416 and a mirror 417 inside the housing 105. The light emitted from the light source 102 is divided into two optical paths of light 104C that is reflected by the beam splitter 416 and travels toward the mirror 417 and light 104D that is transmitted through the beam splitter 416 and travels toward the diaphragm 101. The light 104C reflected by the beam splitter 416 is reflected by the mirror 417, then transmitted through the beam splitter 416, and directed to the light receiving element 103. The light 104D transmitted through the beam splitter 416 is reflected by the diaphragm 101, then reflected by the beam splitter 416, and directed to the light receiving element 103. The light 104C, 104D in the two optical paths is incident on the light receiving element 103 while causing interference. An optical path length of the light 104D reflected by the diaphragm 101 is changed by the vibration of the diaphragm 101. The interference changes due to the change in the optical path length.

### 3. Vibration Detection Principle of Optical Microphone

FIG. 5 is a diagram illustrating an example of a detection principle of the optical microphone according to the embodiment of the present disclosure. FIG. 5 is an example of a vibration detection principle of the example of FIGS. 2 and 4. In a case where the light has coherence, an optical path difference between the two optical paths and a light intensity of the interference light have a relationship as illustrated in FIG. 5. The light intensity of the light emitted from the light source 102 changes at a predetermined cycle based on the wavelength. The light intensity when the optical path difference is d1 is I1, and the light intensity when the optical path difference is d2 is I2. When the diaphragm 101 vibrates, the optical path difference changes between d1 and d2, for example. When the optical path difference changes, the light intensity of the interference light changes between I1 and I2, for example. The ASIC 140 detects the change in the light intensity and converts the change into an audio signal. The example of FIG. 5 is an example in which the change in the light intensity is used as it is, but there is also a method of obtaining an audio signal by applying modulation to the light source and demodulating the light received by the light receiving element 103.

### 4. First Embodiment

### [4.1 Configuration of Optical Microphone of First Embodiment]

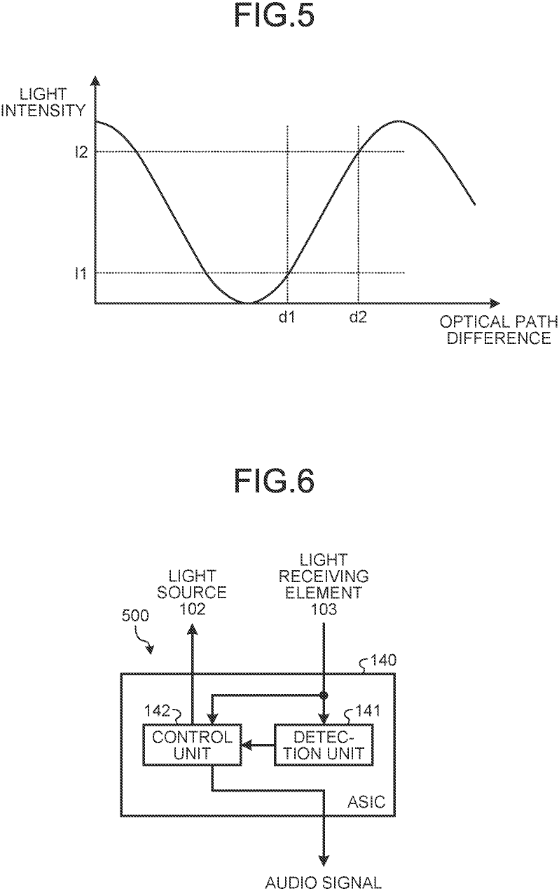

FIG. 6 is a schematic diagram illustrating a configuration of an optical microphone according to a first embodiment of the present disclosure. An optical microphone 500 of the first embodiment includes a detection unit 141 and a control unit 142 for the ASIC 140 in the optical microphone 100 illustrated in FIG. 1. The detection unit 141 checks the output of the light receiving element 103 and detects whether there is an abnormality. The detection unit 141 transmits the detection result to the control unit 142. The control unit 142 causes a processing unit (not illustrated) to convert the output of the light receiving element 103 into an audio signal, and outputs the audio signal from the optical microphone 500. Furthermore, the control unit 142 controls the light intensity which is the output of the light source 102. The control unit 142 has a control mode according to the detection result transmitted from the detection unit 141. The control mode includes a first control mode and a second control mode. The first control mode is a normal use state, in which light 104 is emitted from light source 102, and an audio signal is output according to the output of light receiving element 103. The second control mode is an abnormal state, and is switched from the first control mode when abnormality detection is transmitted from the detection unit 141. In the second control mode, at least one of the light intensity which is the output of the light source 102 or the output (sound output) of the audio signal is controlled as an abnormal state.

### [4.2 Operation of Optical Microphone of First Embodiment]

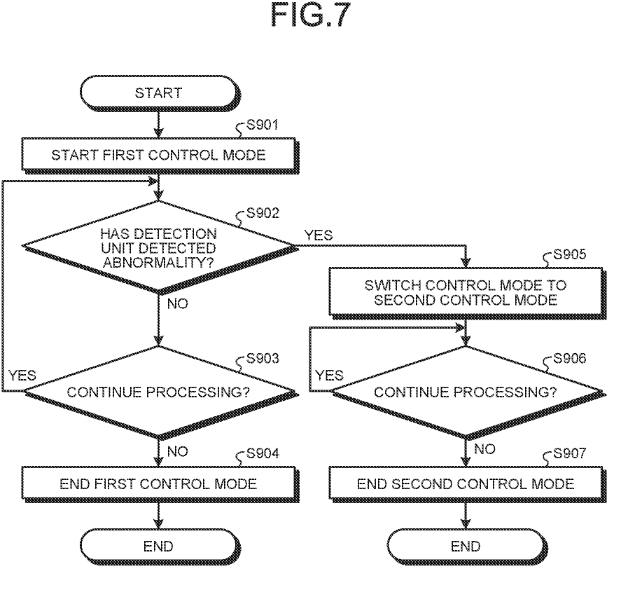

FIG. 7 is a flowchart illustrating an operation of the optical microphone according to the first embodiment of the present disclosure. When the power is turned on, the control unit 142 starts the first control mode in Step S901. That is, the light 104 emitted from the light source 102 is reflected by the diaphragm 101 and enters the light receiving element 103. The control unit 142 converts the output of the light receiving element 103 into an audio signal by a processing unit (not illustrated), and outputs the audio signal from the optical microphone 500. In Step S902, the detection unit 141 checks the output of the light receiving element 103. When an abnormality is detected, the process proceeds to Step S905, and when no abnormality is detected, the process proceeds to Step S903. In Step S903, it is determined whether to continue the processing of the first control mode. In a case where the processing is not continued, an end instruction may be given from a user through an external interface (not illustrated). Furthermore, in a case where the processing is not continued, the user may turn off the power of the optical microphone 500. When the processing is continued, the process returns to Step S902 again. If the processing is not to be continued, the process proceeds to Step S904. In Step S904, the first control mode ends. On the other hand, when an abnormality is detected, the control mode is switched to the second control mode in Step S905. The second control mode is an abnormal state, and controls at least one of the light intensity which is the output of the light source 102 or the output (sound output) of the audio signal as the abnormal state. In Step S906, it is determined whether to continue the processing of the second control mode. In a case where the processing is not continued, an end instruction may be given from a user through an external interface (not illustrated). Furthermore, in a case where the processing is not continued, the user may turn off the power of the optical microphone 500. When the processing is continued, the process returns to Step S906 again. If the processing is not to be continued, the process proceeds to Step S907. In Step S907, the second control mode ends.

### [4.3 Abnormality Detection Principle]

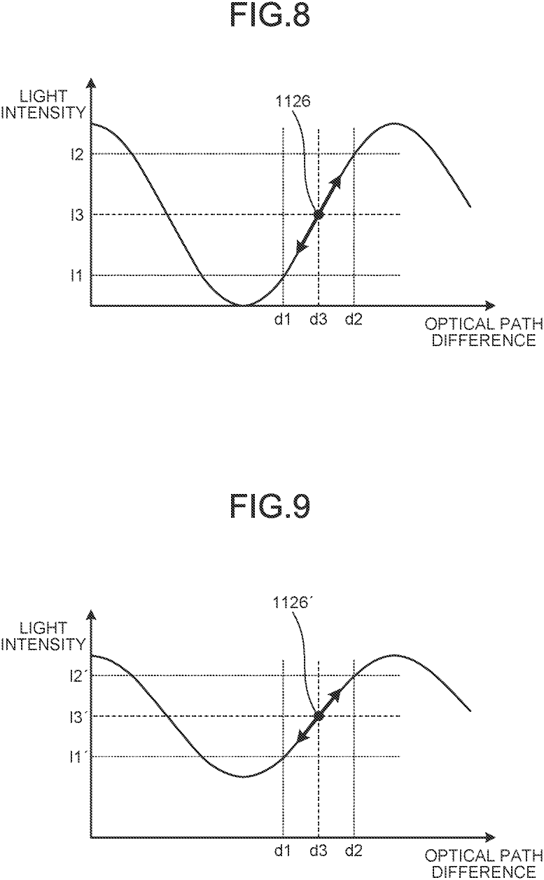

FIGS. 8 and 9 are diagrams illustrating an example of a detection principle of the optical microphone according to the first embodiment of the present disclosure. FIGS. 8 and 9 are examples in which a motion center point 1126 is added to FIG. 5. As illustrated in FIG. 8, in the vibration detection using two-optical path interference, an optical path difference d3 is an optical path difference in a case where there is no vibration of the diaphragm 101, and is an optical path difference that is a center of vibration in a case where there is vibration and represents a center of the optical path differences d1 to d2. A light intensity I3 corresponds to an optical path difference d3. A point connecting the optical path difference d3 and the light intensity I3 is the motion center point 1126. In both the case of silence and the case of presence of sound, an average of the light intensity is the light intensity I3. Here, in a case where the diaphragm 101 is damaged and the light 104 of the light source 102 leaks to the outside of the optical microphone 500, the light intensity of the light 104 from the light source 102 is subtracted from the light intensity of the light incident on the light receiving element 103, and the light intensity of the light incident on the light receiving element significantly decreases. Therefore, in a case where an average of the outputs of the light receiving element 103 is lower than usual, there is a high possibility that an abnormality such as damage of the diaphragm 101 occurs. Conversely, when the diaphragm 101 is damaged, the average output of the light receiving element 103 may be higher than usual. FIG. 9 illustrates a case where a part of the diaphragm 101 is damaged, and light from the outside of the housing 105 enters the housing 105 from a damaged gap. In this case, the light intensity received by the light receiving element 103 is added to the light intensity of the light 104 from the light source 102, and increases as indicated by a light intensity I3′ in FIG. 9, for example. A point connecting the optical path difference d3 and the light intensity I3′ in this case is a motion center point 1126′. In both the case of silence and the case of presence of sound, the average of the light intensity is the light intensity I3′. Note that the light intensities I1′, I2′ correspond to the optical path differences d1, d2 when light from the outside of the housing 105 enters the housing 105 from the damaged gap. As described above, in a case where the average of the outputs of the light receiving element 103 is lower or higher than usual, there is a high possibility that an abnormality such as damage of the diaphragm 101 occurs. In the optical microphone 500 of the present disclosure, abnormality is detected by the detection unit 141 in FIG. 6. The detection unit 141 monitors the average of the outputs from the light receiving element 103, and determines that an abnormality has been detected when the average is lower or higher than usual. In the flow of the processing of FIG. 7, in Step S902, the abnormality can be detected using the average.

### [4.4 Modification Example of Light Receiving Element]

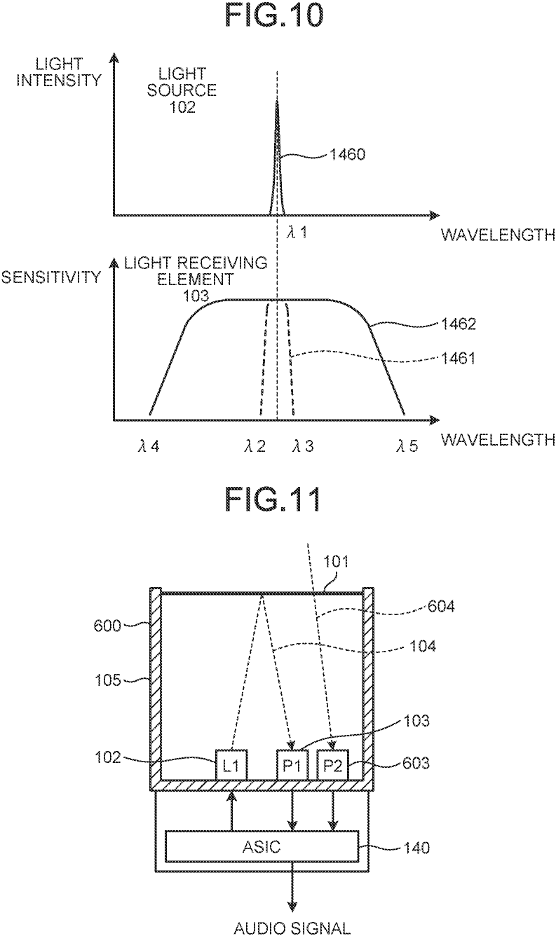

FIG. 10 is a diagram illustrating another example of the detection principle of the optical microphone according to the first embodiment of the present disclosure. For example, when the wavelength of the light 104 of the light source 102 is λ1 and the light intensity thereof is light intensity 1460, a wavelength range λ2 to λ3 (sensitivity 1461) is sufficient as a wavelength range of the light receiving element 103. On the other hand, by setting the wavelength range of the light receiving element 103 to a wider range including the wavelength of the light 104 of the light source 102 such as a wavelength range λ4 to λ5 (sensitivity 1462), light having a wavelength other than the light 104 of the light source 102 (light outside the housing 105) can also be received. As a result, when light outside the housing 105 enters the housing 105 from the gap of the damaged diaphragm 101, abnormality can be detected for light in a wider wavelength range. For the purpose of more reliably detecting light from the outside of the housing 105, it is desirable that the wavelength range of the light receiving element 103 includes a wavelength of visible light. That is, the light receiving element 103 includes at least a wavelength of visible light in its wavelength range. The reason why visible light should be included is that when a user whose safety should be ensured uses the optical microphone 500, there is visible light in the environment in many cases. Note that a light receiving element such as a general photodiode often has left-right asymmetric sensitivity with respect to a wavelength range, but FIG. 10 conceptually illustrates the sensitivity (1461, 1462) of the light receiving element 103.

### [4.5 Another Configuration of Optical Microphone of First Embodiment]

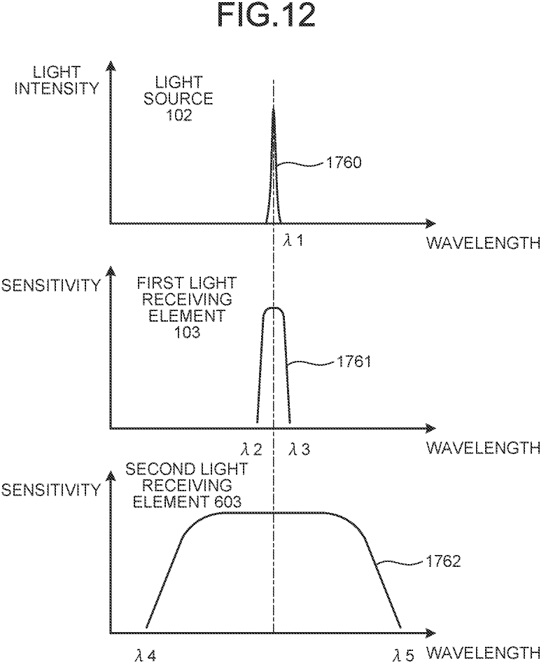

FIG. 11 is a schematic diagram illustrating another configuration of the optical microphone according to the first embodiment of the present disclosure. FIG. 12 is an explanatory diagram of another configuration of FIG. 11. An optical microphone 600 illustrated in FIG. 11 is different from the optical microphone 500(100) in that a second light receiving element 603 is provided. Other equivalent configurations are denoted by the same signs as those of the above-described optical microphone 500(100), and description thereof is omitted. The light receiving element 103 is referred to as a first light receiving element 103. The optical microphone 600 includes the second light receiving element 603 in addition to the first light receiving element 103. As illustrated in FIG. 12, the first light receiving element 103 receives a narrowband wavelength range λ2 to λ3 (sensitivity 1761) including the wavelength of the light 104 of the light source 102 with respect to the wavelength λ1 (light intensity 1760) of the light 104 of the light source 102. That is, the first light receiving element 103 is used to detect vibration of the diaphragm 101. The wavelength range λ2 to λ3 of the first light receiving element 103 may be characteristics of the light receiving element itself, or may be characteristics realized by combining a bandpass filter (not illustrated) with a light receiving element having a wider light receiving range. The second light receiving element 603 receives a wide wavelength range λ4 to λ5 (sensitivity 1761) that compensates for the wavelength range λ2 to λ3 (sensitivity 1762) of the first light receiving element 103. That is, the second light receiving element 603 includes at least the wavelength range λ4 to λ5 other than the wavelength range λ2 to λ3 received by the first light receiving element 103. The wavelength range λ4 to λ5 of the second light receiving element 603 includes wavelengths that the first light receiving element 103 does not receive. The wavelength range λ4 to λ5 of the second light receiving element 603 may or may not include the light receiving range λ2 to λ3 of the first light receiving element 103. The second light receiving element 603 is used to detect light 604 entering the housing 105 from the outside of the housing 105 due to damage of the diaphragm 101 or the like.

In the optical microphone 600, the detection unit 141 of the ASIC 140 checks at least one of the output of the first light receiving element 103 or the output of the second light receiving element 603, and detects an abnormality when the abnormality occurs. The detection unit 141 transmits the detection result to the control unit 142. In the normal state of the first control mode, the first light receiving element 103 receives the light 104 from the light source 102 reflected by the diaphragm 101. Furthermore, in the normal state, the second light receiving element 603 does not receive the light 604 entering the housing 105 from the outside of the housing 105. Therefore, the detection unit 141 does not detect an abnormality. On the other hand, in the abnormal state of the second control mode, the diaphragm 101 is damaged, the second light receiving element 603 receives the light 604 entering the housing 105 from the outside of the housing 105, and the average of the outputs increases. Furthermore, in the abnormal state of the second control mode, in the first light receiving element 103, when the diaphragm 101 is damaged and the light 104 of the light source 102 leaks to the outside of the housing 105, the average of the outputs of the first light receiving element 103 decreases. As a result, the detection unit 141 detects an abnormality. In a case where abnormality detection is transmitted from the detection unit 141, the control unit 142 switches the control mode from the first control mode to the second control mode. An operation of the control unit 142 is similar to the operation illustrated in FIG. 7.

### [4.6 Another Configuration of Optical Microphone of First Embodiment]

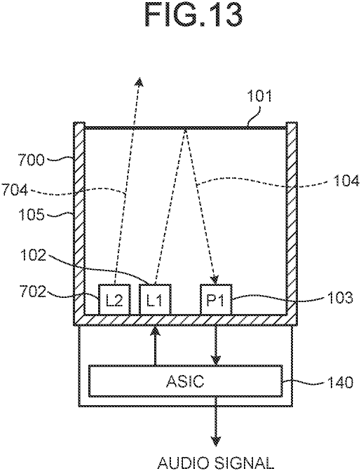

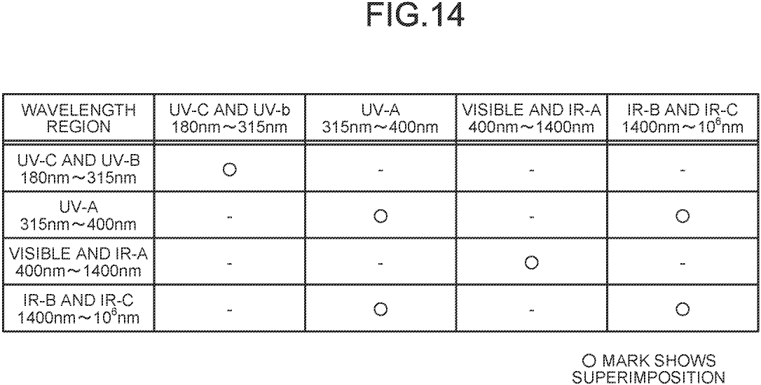

FIG. 13 is a schematic diagram illustrating another configuration of the optical microphone according to the first embodiment of the present disclosure. FIG. 14 is an explanatory diagram of another configuration of FIG. 13. Note that FIG. 14 is cited from Non Patent Literature 1 “Safety Standards of Laser Product” (JIS C 6802, IEC 60825-1). An optical microphone 700 illustrated in FIG. 13 is different from the optical microphone 500(100) in that a second light source 702 is provided. Other equivalent configurations are denoted by the same signs as those of the above-described optical microphone 500(100), and description thereof is omitted. The light source 102 is referred to as a first light source 102. The optical microphone 700 includes the second light source 702 in addition to the first light source 102. The second light source 702 is a class 1 laser. The second light source 702 may be a light source different from the laser. As the second light source 702, for example, a light emitting diode (LED) or the like can be used. The wavelength of light 704 of the second light source 702 is visible light (about 400 nm to 780 nm). The wavelength of the light 104 of the first light source 102 is a wavelength having no superimposing property with visible light (about 400 nm or less, about 1400 nm or more). Here, FIG. 14 illustrates superimposition of the action on the eye by radiation in different wavelength regions. For example, since visible light having a wavelength of 650 nm and IR-A having a wavelength of 850 nm have superimposition, the action on the eye when these two lights are simultaneously irradiated is additive. On the other hand, for example, there is no superimposition between visible light having a wavelength of 650 nm and IR-B having a wavelength of 1500 nm, and thus the risk of the action on the eye in a case where the two lights are simultaneously irradiated is determined by the larger one of the actions on the eye in a case where the lights are independently irradiated. In other words, the risk to the eye does not increase even if two light beams in non-overlapping wavelength regions are simultaneously emitted.

In the optical microphone 700, the detection unit 141 of the ASIC 140 checks the output of the light receiving element 103 as described above, and detects an abnormality when the abnormality occurs. The detection unit 141 transmits the detection result to the control unit 142. In the normal state of the first control mode, the light receiving element 103 receives the light 104 from the light source 102 reflected by the diaphragm 101. Therefore, the detection unit 141 does not detect an abnormality. On the other hand, in the abnormal state of the second control mode, the diaphragm 101 is damaged, the light receiving element 103 receives the light 604 entering the housing 105 from the outside of the housing 105, and the output increases. As a result, the detection unit 141 detects an abnormality. In a case where abnormality detection is transmitted from the detection unit 141, the control unit 142 switches the control mode from the first control mode to the second control mode. An operation of the control unit 142 is similar to the operation illustrated in FIG. 7.

The second light source 702 emits light regardless of the control mode. The purpose of the second light source 702 is to inform the user using the optical microphone 700 that light is leaking from the optical microphone 700. Due to damage to the diaphragm 101 or the like, the light 104 may leak to the outside of the housing 105. In a case where the light 104 of the first light source 102 for detecting the vibration of the diaphragm 101 is visible light, the user can notice that the light 104 leaks, and thus, can take an action to avoid exposure. On the other hand, in a case where the light 104 of the first light source 102 is infrared rays or ultraviolet rays, it is difficult for the user to notice leakage of the light 104 (infrared ray, ultraviolet ray) from the housing 105, and the user may be continuously exposed to the light. Even in such a case, since the light 704 of the second light source 702, which is visible light, leaks together with the light 104 of the first light source 102, the user can easily notice the abnormality. Since the light 104 of the first light source 102 and the light 704 of the second light source 702 are selected from wavelength regions having no superimposition, the risk to the eye does not increase.

The second light source 702 may be turned off in the first control mode and emit light in the second control mode. That is, the control unit 142 performs control to turn off the second light source 702 in the first control mode, and performs control to cause the second light source 702 to emit light in the second control mode. With this control, power consumption can be reduced and the influence of heat by the second light source 702 can be prevented as compared with a case where the second light source 702 is caused to constantly emit light. That is, the second control mode can control at least one of the light intensity that is the output of the first light source 102, the output of the second light source 702, or the sound output that is not based on the output of the first light receiving element 103.

### [4.7 Another Configuration of Optical Microphone of First Embodiment]

FIG. 15 is a schematic diagram illustrating an operation of another configuration of the optical microphone according to the first embodiment of the present disclosure. An optical microphone 800 illustrated in FIG. 15 describes details of an operation by the control unit 142 of the ASIC 140 with respect to the configuration of the optical microphone 500(100) described above, and the same signs as those of the optical microphone 500(100) are given to equivalent configurations, and description thereof is omitted. As illustrated in FIG. 15, when the diaphragm 101 is damaged and an unintended opening 108 is formed, the light 104 of the light source 102 may leak from the opening 108 to the outside of the housing 105. In this case, when abnormality detection is transmitted from the detection unit 141, the control unit 142 switches the control mode to the second control mode. In the second control mode, the control unit 142 performs control to cause the light intensity of the first light source 102 to be zero or close to zero. In the case of approaching zero, it is equivalent to class 1 or less. With this control, light leaking to the outside of the housing 105 can be eliminated, or the intensity can be suppressed to a level that hardly affects the eyes. Note that the operation illustrated in FIG. 15 may be performed in a configuration including second light source 702 illustrated in FIG. 13.

### [4.8 Another Configuration of Optical Microphone of First Embodiment]

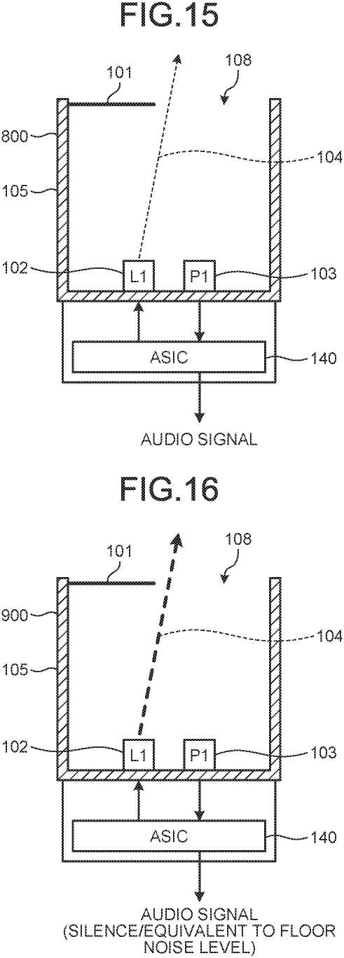

FIG. 16 is a schematic diagram illustrating an operation of another configuration of the optical microphone according to the first embodiment of the present disclosure. An optical microphone 900 illustrated in FIG. 16 describes details of an operation by the control unit 142 of the ASIC 140 with respect to the configuration of the optical microphone 500(100) described above, and the same signs as those of the optical microphone 500(100) are given to equivalent configurations, and description thereof is omitted. As illustrated in FIG. 16, when the diaphragm 101 is damaged and the unintended opening 108 is formed, the light 104 of the light source 102 may leak from the opening 108 to the outside of the housing 105. In this case, when abnormality detection is transmitted from the detection unit 141, the control unit 142 switches the control mode to the second control mode. In the second control mode, the control unit 142 controls the output (sound output) of the audio signal, and sets, for example, a sound output that is not based on the output of the light receiving element 103 and is smaller than the output of the light receiving element 103. Specifically, in the second control mode, the control unit 142 performs control to make the audio signal silent or close to silent. In the case of approaching silence, it is set to be less than or equal to a floor noise level. In a case where the audio signal is a digital signal, the audio signal is silent or digital signal equivalent to or lower than a floor noise level. With this control, it is possible to prevent an audio signal having an unexpected magnitude from being output from the ASIC 140. Here, the floor noise level is a noise level in an extremely quiet environment during normal use of the optical microphone. Note that the operation illustrated in FIG. 16 may be performed together with the operation illustrated in FIG. 15, or may be performed in the configuration illustrated in FIG. 13.

### [4.9 Another Configuration of Optical Microphone of First Embodiment]

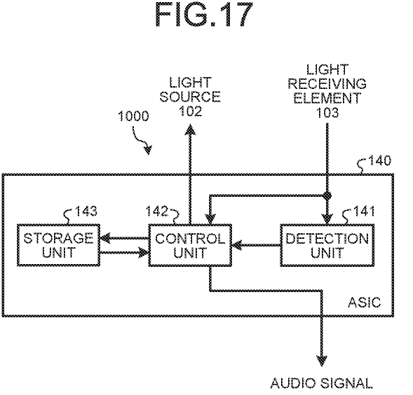

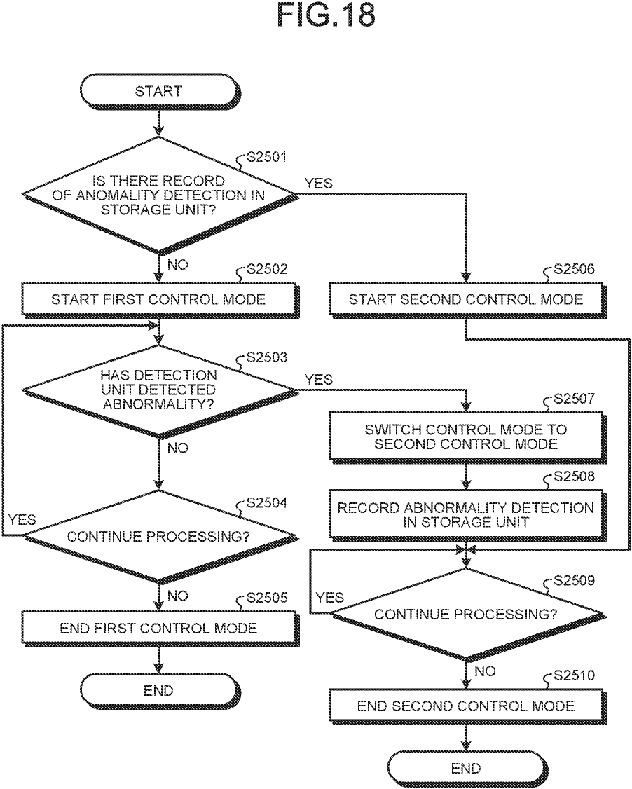

FIG. 17 is a schematic diagram illustrating another configuration of the optical microphone according to the first embodiment of the present disclosure. FIG. 18 is a flowchart illustrating an operation of another configuration of FIG. 17. An optical microphone 1000 illustrated in FIG. 17 is different from the optical microphone 500(100) in that a storage unit 143 is provided in the ASIC 140. Other equivalent configurations are denoted by the same signs as those of the above-described optical microphone 500(100), and description thereof is omitted. The storage unit 143 is a non-volatile storage means, and a flush memory or the like can be used. The storage unit 143 records abnormality detection. In a case where abnormality detection is transmitted from the detection unit 141, the control unit 142 switches the control mode to the second control mode and records the abnormality detection in the storage unit 143.

As illustrated in FIG. 18, when the power is turned on, the optical microphone 1000 checks whether or not there is a record of occurrence of abnormality in the storage unit in Step S2501. If there is a record of abnormality detection, the process proceeds to Step S2506, and if there is no record of abnormality detection, the process proceeds to Step S2502. In Step S2502, the control unit 142 starts the first control mode. That is, the light 104 emitted from the light source 102 is reflected by the diaphragm 101 and enters the light receiving element 103. The control unit 142 converts the output of the light receiving element 103 into an audio signal by a processing unit (not illustrated), and outputs the audio signal from the optical microphone 1000. In Step S2503, the detection unit 141 checks the output of the light receiving element 103. In a case where an abnormality is detected, the process proceeds to Step S2507. When no abnormality is detected, the process proceeds to Step S2504. In Step S2504, it is determined whether to continue the processing of the first control mode. In a case where the processing is not continued, an end instruction may be given from a user through an external interface (not illustrated). Furthermore, in a case where the processing is not continued, the user may turn off the power of the optical microphone 1000. When the processing is continued, the process returns to Step S2503 again. If the processing is not to be continued, the process proceeds to Step S2505. In Step S2505, the first control mode ends. On the other hand, in a case where there is a record of abnormality detection, the second control mode is started in Step S2506, and the process proceeds to Step S2509. Furthermore, in Step S2507 in which the process proceeds when an abnormality is detected in Step S2503, the control mode is switched to the second control mode. The second control mode is an abnormal state, and controls at least one of the light intensity which is the output of the light source 102 or the output (sound output) of the audio signal as the abnormal state. In Step S2508, abnormality detection is recorded in the storage unit 143. In Step S2509, it is determined whether to continue the processing of the second control mode. In a case where the processing is not continued, an end instruction may be given from a user through an external interface (not illustrated). Furthermore, in a case where the processing is not continued, the user may turn off the power of the optical microphone 1000. When the processing is continued, the process returns to Step S2509 again. If the processing is not to be continued, the process proceeds to Step S2510. In Step S2510, the second control mode ends.

The optical microphone 1000 is different from the optical microphone 500(100) in that an abnormality occurrence is recorded in the storage unit 143. When the power is turned on, first, recording in the storage unit 143 is checked. When there is a record of abnormality detection, it is possible to start from the second control mode without going through the first control mode. This prevents the light 104 from leaking from the light source 102 to the outside of the optical microphone.

### [4.10 Configuration of Information Processing Apparatus According to First Embodiment]

FIG. 19 is a schematic diagram illustrating a configuration of an information processing apparatus according to the embodiment of the present disclosure. An information processing apparatus 1 illustrated in FIG. 19 includes a system 150 to which the above-described optical microphone 500(100), 600, 700, 800, 900, 1000 is connected. Examples of the system 150 include a recording device, an amplifier, and a speaker. Therefore, the information processing apparatus 1 illustrated in FIG. 19 can receive an audio signal of the optical microphone 500(100), 600, 700, 800, 900, 1000 and perform audio recording and audio output.

In the information processing apparatus 1 illustrated in FIG. 19, when the detection unit 141 detects an abnormality, the control unit 142 of the ASIC 140 in the optical microphone 500(100), 600, 700, 800, 900, 1000 switches the control mode to the second control mode and outputs an abnormality detection notification signal to the system 150. As described above, the output of the abnormality detection notification signal enables a side of the system 150 to know that the optical microphone 500(100), 600, 700, 800, 900, 1000 has detected an abnormality. The system 150 that has received the abnormality detection notification signal can perform processing based on the notification. For example, in the information processing apparatus 1, the system 150 that has received the abnormality detection notification signal can stop the power supply to the optical microphone 500(100), 600, 700, 800, 900, 1000 on the basis of the notification. Since power supply to the optical microphone 500(100), 600, 700, 800, 900, 1000 is stopped, light can be prevented from leaking from the optical microphone 500(100), 600, 700, 800, 900, 1000.

### [4.11 Another Configuration of Information Processing Apparatus According to First Embodiment]

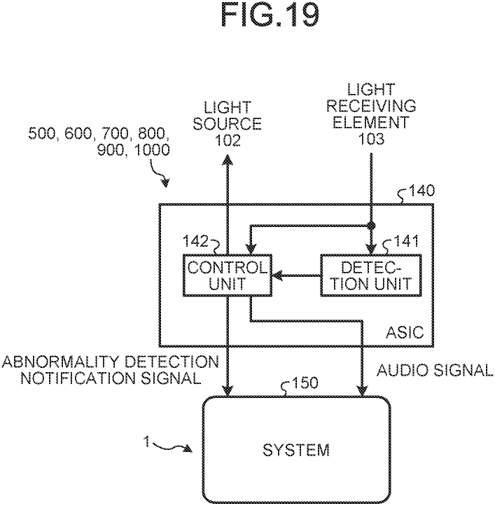

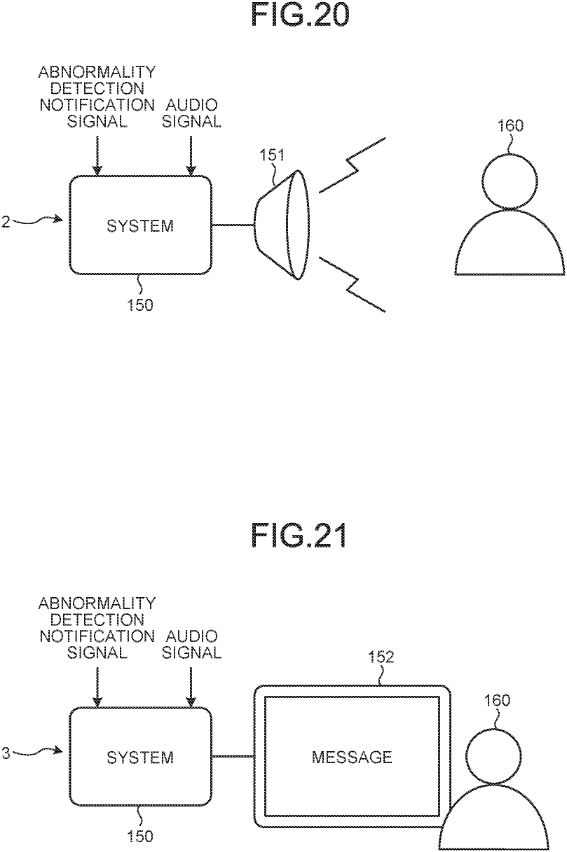

FIGS. 20 and 21 are schematic diagrams illustrating another configuration of the information processing apparatus according to the embodiment of the present disclosure. In information processing apparatuses 2, 3 illustrated in FIGS. 20 and 21, the system 150 includes a notification unit 151,152. Furthermore, in the optical microphone 500(100), 600, 700, 800, 900, 1000, when the detection unit 141 detects an abnormality, the control unit 142 of the ASIC 140 switches the control mode to the second control mode and outputs an abnormality detection notification signal to the system 150. The notification unit 151,152 is a user interface, and notifies a user 160 who uses the system 150 that the optical microphone 500(100), 600, 700, 800, 900, 1000 has detected an abnormality in response to the abnormality detection notification signal. As a result, attention can be attracted to the user 160.

The notification unit 151 illustrated in FIG. 20 is one of user interfaces and is configured as a speaker that performs an auditory notification. The speaker which is the notification unit 151 notifies the user 160 who uses the system 150 of abnormality detection. A sound reproduced from the speaker serving as the notification unit 151 may be a warning sound or a message. For example, if the message is a sentence meaning “the optical microphone has failed”, it is easy to understand the message.

The notification unit 152 illustrated in FIG. 21 is one of user interfaces and is configured as a monitor that performs visual notification. The monitor which is the notification unit 152 notifies the user 160 who uses the system 150 of the abnormality detection. An image displayed on the monitor which is the notification unit 152 may be a warning display such as an icon or a message. For example, if the message is a sentence meaning “the optical microphone has failed”, it is easy to understand the message.

### [4.12 Application Example]

FIGS. 22 to 25 are schematic diagrams illustrating application examples of the optical microphone according to the first embodiment of the present disclosure. Note that, in the application examples of FIGS. 22 to 25, the same components as those of the above-described embodiment are denoted by the same signs, and description thereof is omitted.

FIG. 22 illustrates an application example using an optical fiber. An optical microphone 1100 includes a fiber coupler 161 and an optical fiber 162. Furthermore, although not clearly illustrated in the drawing, the optical microphone 1100 includes an ASIC 140 including a detection unit 141, a control unit 142, and a storage unit 143, and is connected to the system 150. The fiber coupler 161 is disposed outside the housing 105, and the light source 102 and the light receiving element 103 are connected to the fiber coupler 161. The optical fiber 162 is connected to the fiber coupler 161. The optical fiber 162 is disposed such that an end surface 162a reaches the inside of the housing 105. The light 104 emitted from the light source 102 passes through the fiber coupler 161 and the optical fiber 162, is emitted from the end surface 162a, is reflected by the diaphragm 101, and then passes through the end surface 162a, the optical fiber 162, and the fiber coupler 161 again, and is received by the light receiving element 103. In this manner, the light 104 of the light source 102 can be radiated from the outside of the housing 105 to the diaphragm 101 via the optical fiber 162, and the light 104 reflected by the diaphragm 101 can be received by the light receiving element 103 outside the housing 105 via the optical fiber 162. Although an outlet of the light source 102 and an inlet of the light receiving element 103 exist at the same position on the end surface 162a of the optical fiber 162, such a configuration may be adopted. Furthermore, the second light receiving element 603 and the second light source 702 described above can also be disposed outside the housing 105 via the fiber coupler 161 and the optical fiber 162.

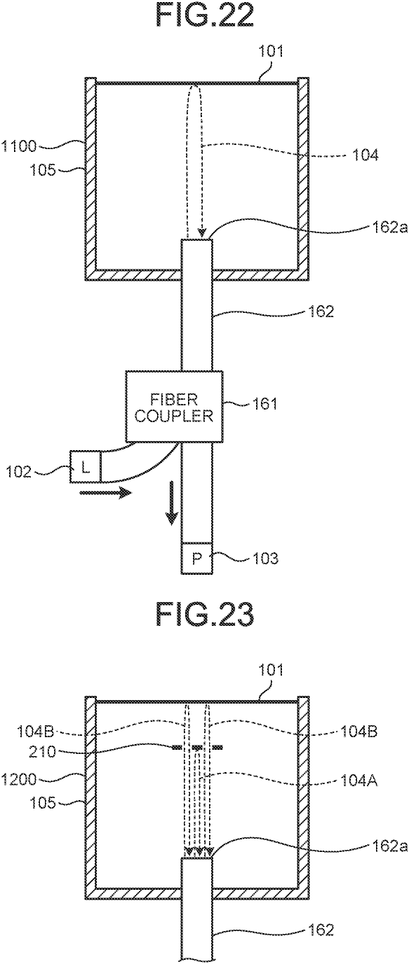

As for the vibration detection method, the configurations illustrated in FIGS. 2 to 4 can be applied. For example, FIG. 23 illustrates an optical microphone 1200 to which the diffraction grating 210 is applied. Light of a light source (not illustrated) emitted from the end surface 162a of the optical fiber 162 is divided into light 104A reflected by the diffraction grating 210 and light 104B passing through the diffraction grating 210. The light 104B having passed through the diffraction grating 210 is reflected by the diaphragm 101 and passes through the diffraction grating 210 again. The light 104A, 104B of these two optical paths is incident on a light receiving element (not illustrated) via the optical fiber 162 while causing interference. Interference occurs depending on a distance between the diffraction grating 210 and the diaphragm 101. Since the diaphragm 101 vibrates by a sound wave, a distance between the diffraction grating 210 and the diaphragm 101 is changed by the sound wave. Since light has a wavelength in a unit of nanometer (nm) to micrometer (µm), vibration of the diaphragm at a nanometer level or less can be detected.

FIG. 24 illustrates an example of an optical microphone 1300 in which the diaphragm 101 has the opening 106. In the optical microphone 1300, the opening 106 as a ventilation hole may be provided in the diaphragm 101 or the like. The purpose of the ventilation hole is to alleviate a pressure difference in the space (cavity) before and after the diaphragm 101. If there is a large pressure difference between the front and rear of the diaphragm 101, sound distortion or damage to the diaphragm 101 may be caused. The pressure difference is caused by a change in atmospheric pressure or a high sound pressure. In FIG. 24, the diaphragm 101 is formed in a circular shape when viewed from a light source direction, and a plurality of the openings 106 is arranged along a circumference of the circular shape. As an example of the opening 106, a hole which is a ventilation hole has been described. However, in addition to this, a slit is provided in the diaphragm 101 in order to control the stress of the diaphragm 101, which is not clearly illustrated in the drawing.

FIG. 25 illustrates an example of an optical microphone 1400 in which the diaphragm 101 has an optical opening 107. There are various materials for the diaphragm 101, and a transparent material may be used. When a transparent material is used, a mirror is formed in a region on the diaphragm 101 where the light of the light source 102 should be reflected. In FIG. 25, the diaphragm 101 is formed in a circular shape when viewed from the light source direction, and a mirror is disposed at a center thereof. The opening 107 is an optical opening, and has a structure in which a part of light is transmitted but air does not pass, such as transparent, translucent, and half mirror. The present disclosure may be the optical microphone 1400 including the opening 107 including the optical opening. Even in the case of the optical microphones 1300, 1400 in which the light outside the housing 105 can be received by the light receiving element 103 at the time of normal use as illustrated in FIGS. 24 and 25, it is possible to detect the abnormality by the fact that the average of the outputs from the light receiving element 103 is lower than normal.

### [4.13 Effects of First Embodiment]

The optical microphone 500(100), 200, 300, 400, 500, 600, 700, 800, 900, 1000, 1100, 1200, 1300, 1400 of the present disclosure detects an abnormality and controls light intensity which is an output of the light source 102 and an output (sound output) of an audio signal, thereby having effects of suppressing leakage of laser light harmful to a human body even if damage occurs and suppressing output of an unexpected audio signal. As a result, the optical microphone 500(100), 200, 300, 400, 500, 600, 700, 800, 900, 1000, 1100, 1200, 1300, 1400 of the present disclosure can suppress leakage of the light 104 of the light source 102 to the outside and can suppress an influence of external light on an output operation.

Note that the effects described in the first embodiment are merely examples and are not limited, and other effects may be provided.

### 5. Second Embodiment

### [5.1 Regarding Optical Microphone of Second Embodiment]

In a second embodiment, the basic configuration, the detection method, and the vibration detection principle of an optical microphone are the same as those described with reference to FIGS. 1 to 5. Therefore, in the description of the optical microphone of the second embodiment, the same components as those of the optical microphone described in the embodiment are denoted by the same signs, and the description thereof is omitted. Furthermore, the optical microphone as a target in the second embodiment is an optical microphone having a configuration in which the opening 106 as a ventilation hole is provided in the diaphragm 101 as illustrated in FIG. 24. Note that, as will be described later, the ventilation hole is not limited to the diaphragm 101, and may be provided in the housing 105 (see FIG. 34 and the like). Furthermore, the optical microphone targeted in the second embodiment includes a directional microphone. In the directional optical microphone, for example, a sound intake port is provided in the housing 105 so as to receive sound waves from one side and the other side of the diaphragm 101 (see FIG. 30 and the like).

### [5.2 Configuration of Optical Microphone Of Second Embodiment]

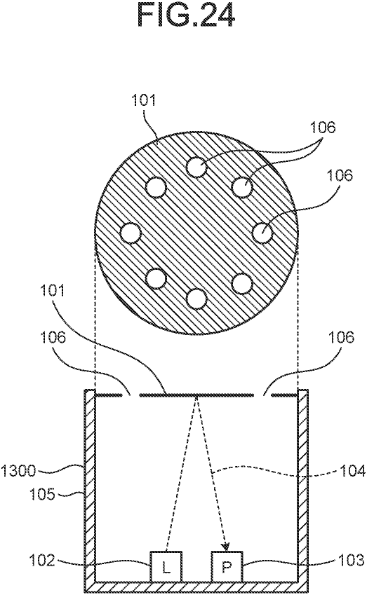

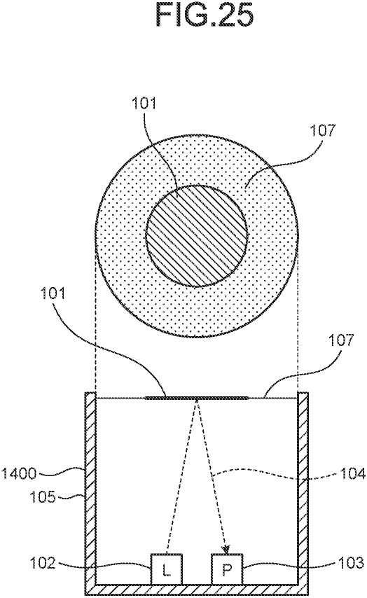

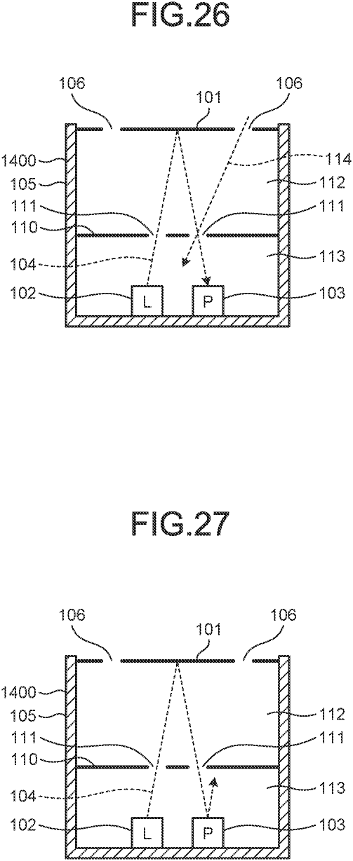

FIGS. 26 and 27 are schematic diagrams illustrating a configuration of an optical microphone according to the second embodiment of the present disclosure. As illustrated in FIGS. 26 and 27, in the optical microphone 1400, the opening (first opening) 106 is formed in the diaphragm 101 as a ventilation hole. That is, the first opening 106 is intentionally formed. In the first opening 106, similarly to the configuration illustrated in FIG. 24, the diaphragm 101 is formed in a circular shape when viewed from the light source direction, and a plurality of the openings 106 is arranged along the circumference of the circular shape. However, the present invention is not limited to this configuration. Furthermore, in the optical microphone 1400, a partition 110 is provided inside the housing 105. The partition 110 separates the inside of the housing 105 between the diaphragm 101 and the first opening 106, and at least the light receiving element 103. In FIGS. 26 and 27, the partition 110 separates the inside of the housing 105 into a first cavity 112 on a side of the diaphragm 101 including the first opening 106 and a second cavity 113 on a side where the light source 102 and the light receiving element 103 are disposed. An opening (second opening) 111 is formed in the partition 110. The second opening 111 does not prevent the light 104 of the light source 102 from being reflected by the diaphragm 101 and received by the light receiving element 103. That is, the second opening 111 of the partition 110 and the light receiving element 103 are disposed on a straight line with respect to a direction in which the light 104 of the light source 102 is reflected by the diaphragm 101 and arrives. Furthermore, the first opening 106, the second opening 111, and the light receiving element 103 of the diaphragm 101 are disposed out of a straight line.

### [5.3 Working of Optical Microphone 1400]

As illustrated in FIG. 26, the light 104 emitted from the light source 102 is reflected by a surface of the diaphragm 101 on a side of the light source 102, and is incident on the light receiving element 103. The light 104 transmits information of vibration of the diaphragm to the light receiving element 103 by an optical action (not illustrated). The output of the light receiving element 103 is processed by a processing unit (not illustrated) to convert the vibration of the diaphragm 101 into an audio signal. Here, as illustrated in FIG. 26, the external light 114 that has entered the first cavity 112 inside the housing 105 from the outside of the housing 105 through the first opening 106 passes a part thereof through the second opening 111 to the second cavity 113. However, since the first opening 106, the second opening 111, and the light receiving element 103 are disposed out of a straight line, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 27, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 110, and remains in the second cavity 113. Furthermore, since the first opening 106, the second opening 111, and the light receiving element 103 are disposed out of a straight line, a part of the light 104 reflected by the light receiving element 103 is blocked by the partition 110 and does not leak from the first opening 106 to the outside of the housing 105. As a result, it is possible to suppress leakage of the light 104 of the light source 102 to the outside of the housing 105.

### [5.4 Another Configuration of Optical Microphone of Second Embodiment]

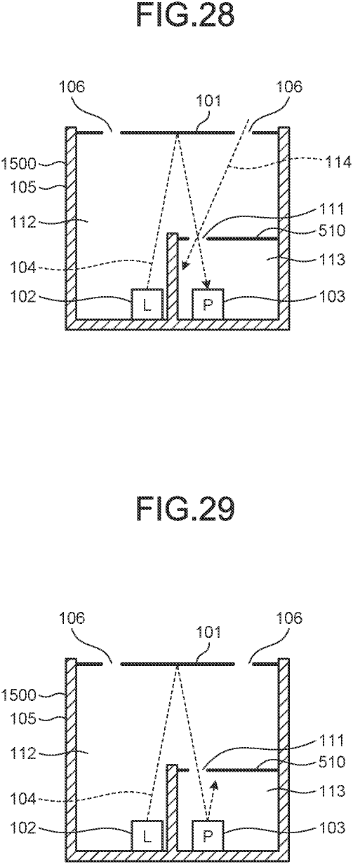

FIGS. 28 and 29 are schematic diagrams illustrating another configuration of the optical microphone according to the second embodiment of the present disclosure. An optical microphone 1500 illustrated in FIGS. 28 and 29 is different from the optical microphone 1400 illustrated in FIGS. 26 and 27 in a configuration of a partition 510. The partition 510 is provided inside the housing 105. The partition 510 separates the inside of the housing 105 between the diaphragm 101 and at least the light receiving element 103. In FIGS. 28 and 29, the partition 510 separates the inside of the housing 105 into a first cavity 112 on a side where the diaphragm 101, the first opening 106, and the light source 102 are disposed and a second cavity 113 on a side where the light receiving element 103 is disposed. The partition 510 also separates the light source 102 and the light receiving element 103 from each other. The light source 102 and the light receiving element 103 may not be separated from each other. An opening (second opening) 111 is formed in the partition 510. The second opening 111 does not prevent the light 104 of the light source 102 from being reflected by the diaphragm 101 and received by the light receiving element 103. That is, the second opening 111 of the partition 510 and the light receiving element 103 are disposed on a straight line with respect to a direction in which the light 104 of the light source 102 is reflected by the diaphragm 101 and arrives. Furthermore, the first opening 106, the second opening 111, and the light receiving element 103 of the diaphragm 101 are disposed out of a straight line.

### [5.5 Working of Optical Microphone 1500]

As illustrated in FIG. 28, the external light 114 that has entered the first cavity 112 inside the housing 105 from outside the housing 105 through the first opening 106 passes a part thereof through the second opening 111 to the second cavity 113. However, since the first opening 106, the second opening 111, and the light receiving element 103 are disposed out of a straight line, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 29, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 510, and remains in the second cavity 113. Furthermore, since the first opening 106, the second opening 111, and the light receiving element 103 are disposed out of a straight line, a part of the light 104 reflected by the light receiving element 103 is blocked by the partition 510 and does not leak from the first opening 106 to the outside of the housing 105. As a result, it is possible to suppress leakage of the light 104 of the light source 102 to the outside of the housing 105.

### [5.6 Another Configuration of Optical Microphone of Second Embodiment]

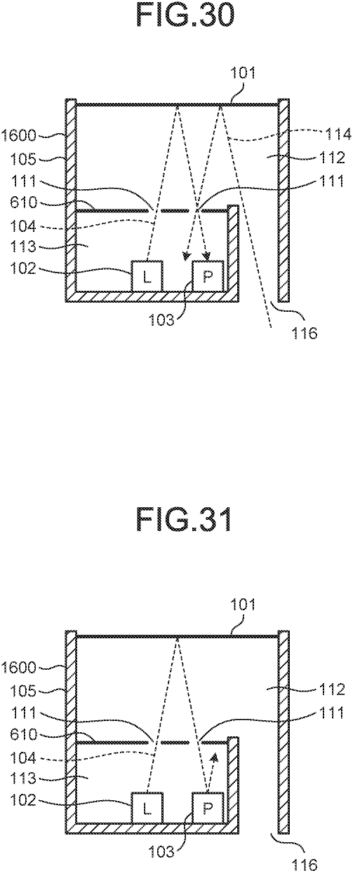

FIGS. 30 and 31 are schematic diagrams illustrating another configuration of the optical microphone according to the second embodiment of the present disclosure. An optical microphone 1600 illustrated in FIGS. 30 and 31 is a directional microphone. The optical microphone 1600 does not have a ventilation hole in the diaphragm 101. The optical microphone 1600 has an opening (first opening) 116 serving as a sound intake port for sound collection that receives a sound wave not only from the outside of the housing 105 which is one side of the diaphragm 101 but also from the inside of the housing 105 which is the other side of the diaphragm 101. The first opening 116 is formed in the housing 105. That is, the first opening is disposed without a partition 610 between the diaphragm 101 and the first opening 116. Furthermore, in the optical microphone 1600, the partition 610 is provided inside the housing 105. The partition 610 separates the inside of the housing 105 between the diaphragm 101 and at least the light receiving element 103. In FIGS. 30 and 31, the partition 610 separates the inside of the housing 105 into a first cavity 112 on a side of the diaphragm 101 and including the first opening 116 of the housing 105 and a second cavity 113 on a side where the light source 102 and the light receiving element 103 are disposed. An opening (second opening) 111 is formed in the partition 610. The second opening 111 does not prevent the light 104 of the light source 102 from being reflected by the diaphragm 101 and received by the light receiving element 103. That is, the second opening 111 of the partition 610 and the light receiving element 103 are disposed on a straight line with respect to a direction in which the light 104 of the light source 102 is reflected by the diaphragm 101 and arrives. Furthermore, the first opening 116, the second opening 111, and the light receiving element 103 of the housing 105 are disposed out of a straight line including a mirror image up to one reflection.

### [5.7 Working of Optical Microphone 1600]

As illustrated in FIG. 30, the light 104 emitted from the light source 102 is reflected by a surface of the diaphragm 101 on a side of the light source 102, and is incident on the light receiving element 103. The light 104 transmits information of vibration of the diaphragm to the light receiving element 103 by an optical action (not illustrated). The output of the light receiving element 103 is processed by a processing unit (not illustrated) to convert the vibration of the diaphragm 101 into an audio signal. Here, as illustrated in FIG. 30, the external light 114 entering the first cavity 112 inside the housing 105 from the outside of the housing 105 through the first opening 116 is reflected by the diaphragm 101, and a part thereof passes through the second opening 111 to the second cavity 113. However, since first opening 116, second opening 111, and light receiving element 103 are disposed out of a straight line including a mirror image up to one reflection, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 31, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 610, and remains in the second cavity 113. Furthermore, since the first opening 116, the second opening 111, and the light receiving element 103 are disposed out of a straight line including a mirror image up to one reflection, a part of the light 104 reflected by the light receiving element 103 is blocked by the partition 610 and does not leak from the first opening 116 to the outside of the housing 105. As a result, it is possible to suppress leakage of the light 104 of the light source 102 to the outside of the housing 105.

### [5.8 Another Configuration of Optical Microphone of Second Embodiment]

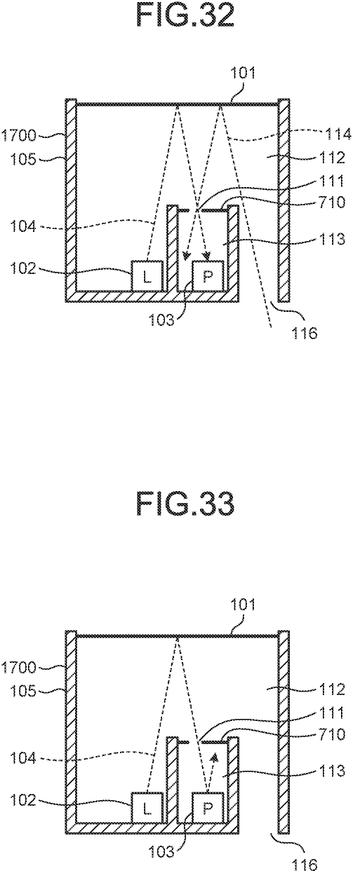

FIGS. 32 and 33 are schematic diagrams illustrating another configuration of the optical microphone according to the second embodiment of the present disclosure. An optical microphone 1700 illustrated in FIGS. 32 and 33 is a directional microphone. The optical microphone 1700 does not have a ventilation hole in the diaphragm 101. The optical microphone 1700 has an opening (first opening) 116 serving as a sound intake port for sound collection that receives a sound wave not only from the outside of the housing 105 which is one side of the diaphragm 101 but also from the inside of the housing 105 which is the other side of the diaphragm 101. The first opening 116 is formed in the housing 105. That is, the first opening 116 is disposed without a partition 710 between the diaphragm 101 and the first opening 116. In the optical microphone 1700, the partition 710 is provided inside the housing 105. The partition 710 separates the inside of the housing 105 between the diaphragm 101 and at least the light receiving element 103. In FIGS. 32 and 33, the partition 710 separates the inside of the housing 105 into a first cavity 112 on a side where the diaphragm 101 and the light source 102 are disposed and a second cavity 113 on a side where the light receiving element 103 is disposed. The partition 710 also separates the light source 102 and the light receiving element 103 from each other. The light source 102 and the light receiving element 103 may not be separated from each other. An opening (second opening) 111 is formed in the partition 710. The second opening 111 does not prevent the light 104 of the light source 102 from being reflected by the diaphragm 101 and received by the light receiving element 103. That is, the second opening 111 of the partition 710 and the light receiving element 103 are disposed on a straight line with respect to a direction in which the light 104 of the light source 102 is reflected by the diaphragm 101 and arrives. Furthermore, the first opening 116, the second opening 111, and the light receiving element 103 of the housing 105 are disposed out of a straight line including a mirror image up to one reflection.

### [5.9 Working of Optical Microphone 1700]

As illustrated in FIG. 32, the external light 114 entering the first cavity 112 inside the housing 105 from the outside of the housing 105 through the first opening 116 is reflected by the diaphragm 101, and a part thereof passes through the second opening 111 to the second cavity 113. However, since first opening 116, second opening 111, and light receiving element 103 are disposed out of a straight line including a mirror image up to one reflection, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 33, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 710, and remains in the second cavity 113. Furthermore, since the first opening 116, the second opening 111, and the light receiving element 103 are disposed out of a straight line including a mirror image up to one reflection, a part of the light 104 reflected by the light receiving element 103 is blocked by the partition 710 and does not leak from the first opening 116 to the outside of the housing 105. As a result, it is possible to suppress leakage of the light 104 of the light source 102 to the outside of the housing 105.

### [5.10 Another Configuration of Optical Microphone of Second Embodiment]

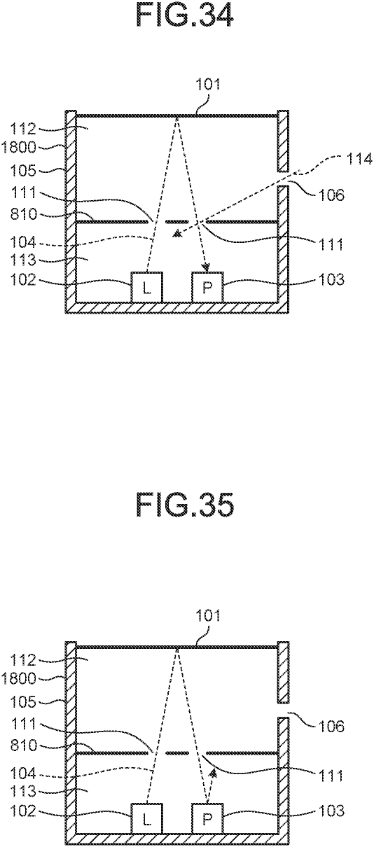

FIGS. 34 and 35 are schematic diagrams illustrating another configuration of the optical microphone according to the second embodiment of the present disclosure. In an optical microphone 1800 illustrated in FIGS. 34 and 35, the opening (first opening) 106 is formed in the housing 105 as a ventilation hole. That is, the first opening 106 is intentionally formed. In the optical microphone 1800, a partition 810 is provided inside the housing 105. The partition 810 separates the inside of the housing 105 between the diaphragm 101 and the first opening 106, and at least the light receiving element 103. In FIGS. 34 and 35, the partition 810 separates the inside of the housing 105 into a first cavity 112 on a side of the diaphragm 101 including the first opening 106 and a second cavity 113 on a side where the light source 102 and the light receiving element 103 are disposed. An opening (second opening) 111 is formed in the partition 810. The second opening 111 does not prevent the light 104 of the light source 102 from being reflected by the diaphragm 101 and received by the light receiving element 103. That is, the second opening 111 of the partition 810 and the light receiving element 103 are disposed on a straight line with respect to a direction in which the light 104 of the light source 102 is reflected by the diaphragm 101 and arrives. Furthermore, the first opening 106, the second opening 111, and the light receiving element 103 of the diaphragm 101 are disposed out of a straight line.

### [5.11 Working of Optical Microphone 1800]

As illustrated in FIG. 34, the external light 114 that has entered the first cavity 112 inside the housing 105 from outside the housing 105 through the first opening 106 passes a part thereof through the second opening 111 to the second cavity 113. However, since the first opening 106, the second opening 111, and the light receiving element 103 are disposed out of a straight line, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 35, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 810, and remains in the second cavity 113. Furthermore, since the first opening 106, the second opening 111, and the light receiving element 103 are disposed out of a straight line, a part of the light 104 reflected by the light receiving element 103 is blocked by the partition 810 and does not leak from the first opening 106 to the outside of the housing 105. As a result, it is possible to suppress leakage of the light 104 of the light source 102 to the outside of the housing 105.

### [5.12 Another Configuration of Optical Microphone of Second Embodiment]

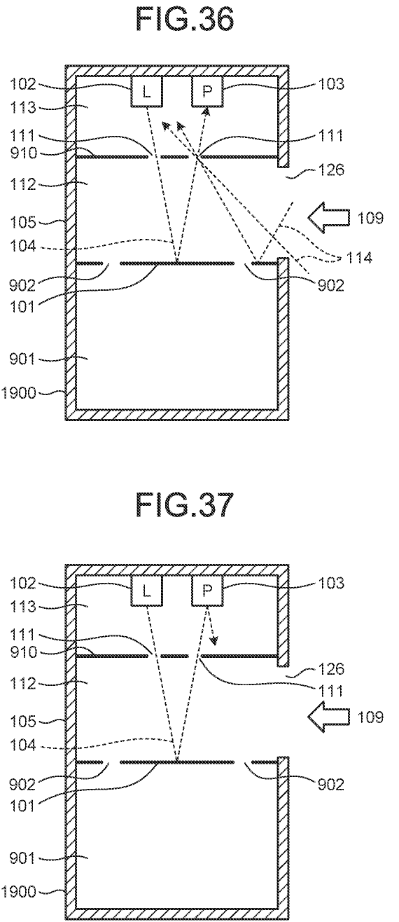

FIGS. 36 and 37 are schematic diagrams illustrating another configuration of the optical microphone according to the second embodiment of the present disclosure. An optical microphone 1900 illustrated in FIGS. 36 and 37 has a back cavity. In the optical microphone 1900, a back cavity 901 partitioned by the diaphragm 101 is formed in the housing 105. The light source 102 and the light receiving element 103 are disposed inside the housing 105 on an opposite side of the back cavity 901 via the diaphragm 101. Here, a side on which the light source 102 and the light receiving element 103 are disposed can be referred to as a front side of the diaphragm 101, and a side on which the back cavity 901 is disposed can be referred to as a rear side of the diaphragm 101. Furthermore, the optical microphone 1900 has an opening (first opening) 126 forming a sound intake port for sound collection that receives sound waves. The first opening 126 is formed in the housing 105 on the front side of the diaphragm 101. That is, the first opening 126 receives the sound wave 109 from the outside of the housing 105 to the front side of the diaphragm 101. Furthermore, in the optical microphone 1900, a partition 910 is provided inside the housing 105. The partition 910 separates the inside of the housing 105 on the front side of the diaphragm 101 between the diaphragm 101 and the first opening 126, and at least the light receiving element 103. In FIGS. 36 and 37, the partition 910 separates the inside of the housing 105 on the front side of the diaphragm 101 into a first cavity 112 on a side of the diaphragm 101 including the first opening 126 and a second cavity 113 on a side where the light source 102 and the light receiving element 103 are disposed. An opening (second opening) 111 is formed in the partition 910. The second opening 111 does not prevent the light 104 of the light source 102 from being reflected by the diaphragm 101 and received by the light receiving element 103. That is, the second opening 111 of the partition 910 and the light receiving element 103 are disposed on a straight line with respect to a direction in which the light 104 of the light source 102 is reflected by the diaphragm 101 and arrives. Furthermore, the first opening 126, the second opening 111, and the light receiving element 103 of the housing 105 are disposed out of a straight line. Furthermore, the first opening 126, the second opening 111, and the light receiving element 103 of the housing 105 are disposed out of a straight line including a mirror image up to one reflection. Note that, in the optical microphone 1900, an opening 902 which is a ventilation hole is provided in the diaphragm 101 or the housing 105 forming the back cavity 901.

### [5.13 Working of Optical Microphone 1900]

As illustrated in FIG. 36, the external light 114 that has entered the first cavity 112 inside the housing 105 from outside the housing 105 through the first opening 126 passes a portion thereof through the second opening 111 to the second cavity 113. However, since the first opening 126, the second opening 111, and the light receiving element 103 are disposed out of a straight line, the external light 114 does not directly reach the light receiving element 103. Furthermore, the external light 114 that has entered the first cavity 112 inside the housing 105 from the outside of the housing 105 through the first opening 126 is partially reflected by the front side of the diaphragm 101 and travels to the second cavity 113 through the second opening 111. However, since the first opening 126, the second opening 111, and the light receiving element 103 are disposed out of a straight line including a mirror image up to one reflection, the external light 114 does not directly reach the light receiving element 103. The external light 114 is diffracted when passing through the second opening 111, and the path is slightly widened, but the light intensity of the diffracted light significantly decreases as a diffraction angle increases. This can prevent the external light 114 from entering the light receiving element 103.

As illustrated in FIG. 37, the light 104 from the light source 102 is reflected by the diaphragm 101 and travels toward the light receiving element 103. The light 104 is partially reflected on a light receiving surface of the light receiving element 103. However, most of the part of the light 104 reflected by the light receiving element 103 is reflected, absorbed, and diffused by the partition 910, and remains in the second cavity 113. Furthermore, since the first opening 126, the second opening 111, and the light receiving element 103 are disposed out of a straight line, a part of the light 104 reflected by the light receiving element 103 is blocked by the partition 910 and does not leak from the first opening 126 to the outside of the housing 105. As a result, it is possible to suppress leakage of the light 104 of the light source 102 to the outside of the housing 105.

### [5.14 Another Configuration of Optical Microphone of Second Embodiment]

FIG. 38 is a schematic diagram illustrating another configuration of the optical microphone according to the second embodiment of the present disclosure. An optical microphone 2000 illustrated in FIG. 38 is based on the optical microphone 1400 illustrated in FIG. 26. The optical microphone 2000 includes a bandpass filter 118 on a light receiving surface of the light receiving element 103. The bandpass filter 118 efficiently transmits the wavelength of light of the light source 102 and attenuates light in other wavelength bands. The bandpass filter 118 can be applied to the optical microphones 1400, 1500, 1600, 1700, 1800, 1900 having the first openings 106, 116, 126 and the second opening 111.

### [5.15 Working of Optical Microphone 2000]

The external light 114 that has entered the first cavity 112 inside the housing 105 from outside the housing 105 through the first opening 106 passes a part thereof through the second opening 111 to the second cavity 113. However, since the first opening 106, the second opening 111, and the light receiving element 103 are disposed out of a straight line, the external light 114 does not directly reach the light receiving element 103. The external light 114 is diffracted when passing through the second opening 111, and the path is slightly widened, but the light intensity of the diffracted light significantly decreases as a diffraction angle increases. Furthermore, among the diffracted light, light in a wavelength band different from that of the light source 102 is further attenuated in the bandpass filter 118. This can prevent the external light 114 from entering the light receiving element 103.

### [5.16 Another Configuration of Optical Microphone of Second Embodiment]

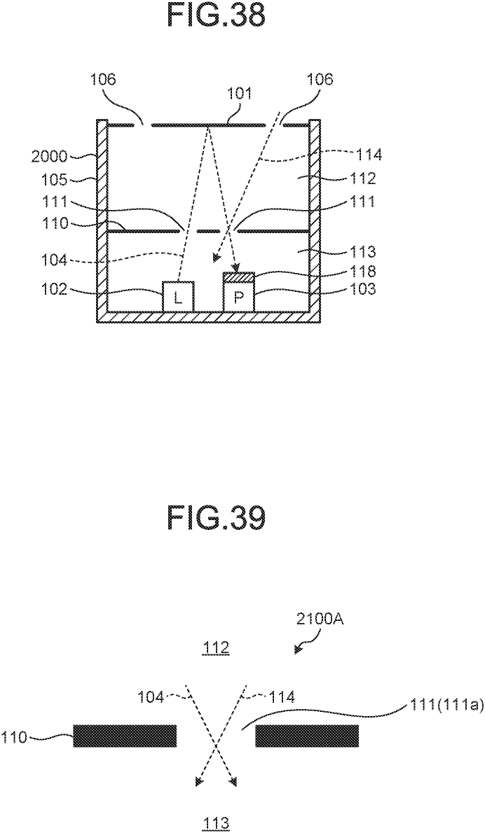

FIGS. 39 to 42 are schematic diagrams illustrating another configuration of the optical microphone according to the second embodiment of the present disclosure. In FIGS. 39 to 42, optical microphones 2100A to 2100D illustrate a second opening 111 in an enlarged manner. The second opening 111 illustrated in FIGS. 39 to 42 can be applied to that formed in the partition 110, 510, 610, 710, 810, 910 described above, and a sign 110 is attached as the partition for convenience of description. The light 104 emitted from the light source 102 passes through the second opening 111 in the process of being reflected by the diaphragm 101 and entering the light receiving element 103. The external light 114, 116 entering from the outside of the housing 105 passes through the second opening 111.

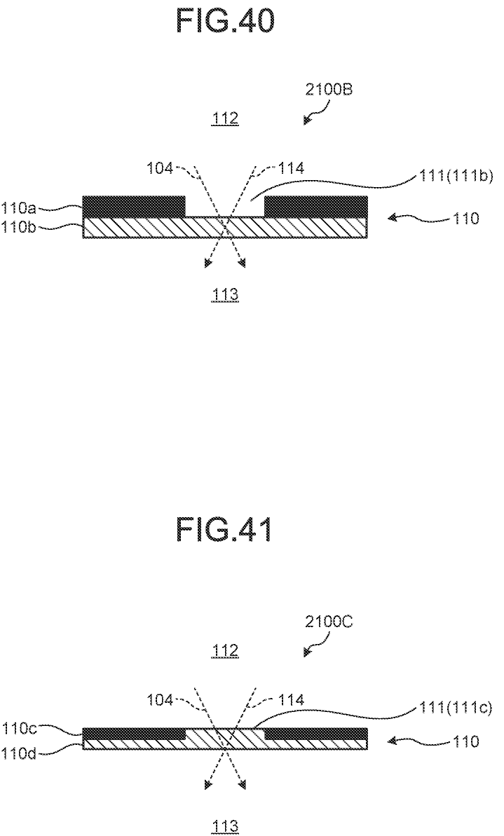

A second opening 111a of the optical microphone 2100A illustrated in FIG. 39 is formed by a through hole and is a physical opening through which air can pass in addition to light. Furthermore, second openings 111b, 111c, 111d illustrated in FIGS. 40 to 42 are examples of optical openings through which light can pass but air cannot pass.

The partition 110 of the optical microphone 2100B illustrated in FIG. 40 includes a first partition 110a and a second partition 110b. The second partition 110b is disposed on one side of the first partition 110a. The first partition 110a and the second partition 110b constitute the second opening 111b. The second opening 111b formed by the first partition 110a is formed by a through hole. The second opening 111b formed by the second partition 110b is formed of glass as a light-transmissive member. The partition 110 illustrated in FIG. 40 can be formed by patterning the first partition 110a on glass of the second partition 110b made of glass.

The partition 110 of the optical microphone 2100C illustrated in FIG. 41 includes a first partition 110c and a second partition 110d. The second partition 110d is disposed on one side of the first partition 110c. The first partition 110c and the second partition 110d constitute the second opening 111c. The second opening 111c formed by the first partition 110c is formed as a through hole. The second opening 111c formed by the second partition 110d is formed of glass as a light-transmissive member. The partition 110 illustrated in FIG. 41 can be formed by making a part of glass of the second partition 110d made of glass opaque by a chemical reaction or the like.

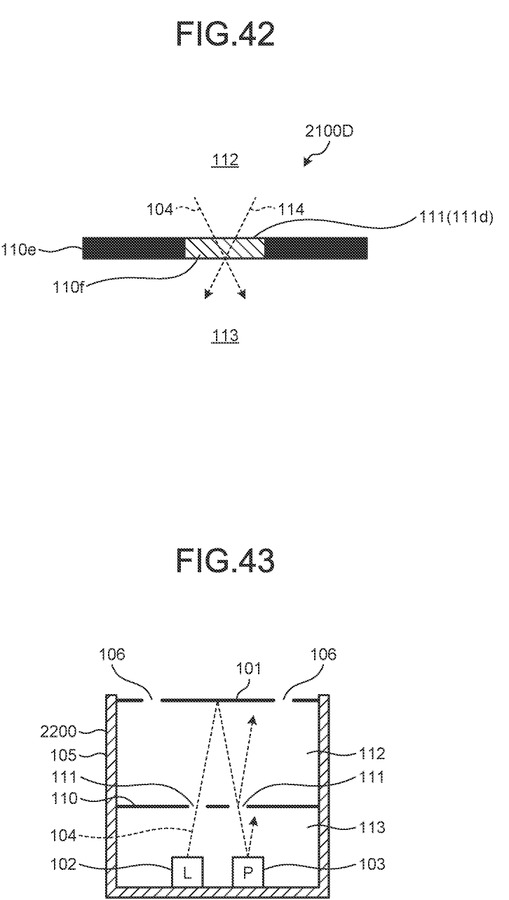

The partition 110 of the optical microphone 2100D illustrated in FIG. 42 includes a first partition 110e and a second partition 110f. The second partition 110f is disposed in a through hole formed in the first partition 110e. The first partition 110e and the second partition 110f constitute the second opening 111d. The second opening 111d formed by the first partition 110e is formed as a through hole. The second opening 111d formed by the second partition 110f is formed of glass as a light-transmissive member. The partition 110 illustrated in FIG. 42 can be formed by filling a through hole of the first partition 110e with glass of the second partition 110f.

The optical openings such as the second openings 111b, 111c, 111d illustrated in FIGS. 40 to 42 improve the degree of freedom in designing the cavity adjacent to the diaphragm 101. When air is also allowed to pass as in the second opening 111a illustrated in FIG. 39, it is necessary to design the second cavity 113 to include ventilation. Moreover, the optical openings such as the second openings 111b, 111c, 111d improve the degree of freedom in design and manufacture of the partition 110.

### [5.17 Another Configuration of Optical Microphone of Second Embodiment]

FIG. 43 is a schematic diagram illustrating another configuration of the optical microphone according to the second embodiment of the present disclosure. An optical microphone 2200 illustrated in FIG. 43 is based on the optical microphone 1400 illustrated in FIG. 26. In the optical microphone 2200, a second opening 111 is configured as the optical second openings 111b, 111c, 111d illustrated in FIGS. 40 to 42. The second opening 111 and the light receiving element 103 are disposed on a straight line with respect to an arrival direction of the light 104 from the light source 102. Moreover, the first opening 106, the second opening 111, and the light source 102 are disposed out of a straight line including a mirror image up to two reflections.

### [5.18 Working of Optical Microphone 2200]

The light 104 emitted from the light source 102 is reflected by the diaphragm 101, passes through the second opening 111, and enters the light receiving element 103. When passing through the second opening 111, a part of the light 104 is reflected toward the diaphragm 101. Since the first opening 106, the second opening 111, and the light source 102 are disposed out of a straight line including the mirror image up to two times of reflection, it is possible to suppress leakage of reflected light from the first opening 106 to the outside of the housing 105.

### [5.19 Another Configuration of Optical Microphone of Second Embodiment]

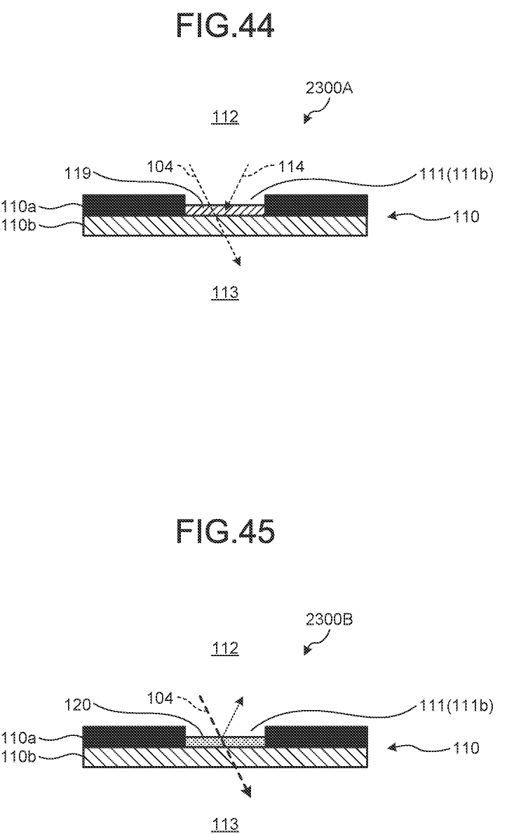

FIGS. 44 and 45 are schematic diagrams illustrating another configuration of the optical microphone according to the second embodiment of the present disclosure. In FIGS. 44 and 45, optical microphones 2300A and 2300B illustrate a second opening 111 in an enlarged manner. The second opening 111 illustrated in FIGS. 44 and 45 can be applied to that formed in the partition 110, 510, 610, 710, 810, 910 described above, and a sign 110 is attached as the partition for convenience of description. The light 104 emitted from the light source 102 passes through the second opening 111 in the process of being reflected by the diaphragm 101 and entering the light receiving element 103. The external light 114,116 entering from the outside of the housing 105 passes through the second opening 111. Furthermore, the second opening 111 can be applied to the optical second openings 111b, 111c, 111d illustrated in FIGS. 41 to 42, and the second opening 111b is illustrated for convenience of description.

In the second opening 111b of the optical microphone 2300A illustrated in FIG. 44, a bandpass filter 119 is provided on a glass surface of the second partition 110b. The bandpass filter 119 efficiently passes the wavelength of the light 104 of the light source 102 and attenuates light in other wavelength bands. Note that the glass of the second partition 110b forming the second opening 111b may have a bandpass filter function. The optical microphone 2300A can prevent the external light 114,116 from entering the second cavity 113 by disposing the bandpass filter 119 in the second opening 111b or providing the second opening 111b with a function of the bandpass filter. This can prevent the external light 114,116 from entering the light receiving element 103.

In the second opening 111b of the optical microphone 2300B illustrated in FIG. 45, an antireflection film 120 is provided on a glass surface of the second partition 110b. The antireflection film 120 is provided toward the diaphragm 101 and toward a side of the arrival direction of the light 104 of the light source 102 reflected by the diaphragm 101. In the optical microphone 2300B, when the light 104 is incident on the second opening 111b, the antireflection film 120 prevents a part of the light from being reflected. This can further suppress leakage of the reflected light to the outside of the housing 105.

### [5.20 Application Example]

The technologies of the optical microphones 1400, 1500, 1600, 1700, 1800, 1900, 2000, 2100A, 2100B, 2100C, 2100D, 2200, 2300A, 2300B according to the second embodiment described above can be applied to the optical microphones 1100, 1200 using optical fibers illustrated in FIGS. 22 and 23.

Furthermore, the technologies of the optical microphones 1400, 1500, 1600, 1700, 1800, 1900, 2000, 2100A, 2100B, 2100C, 2100D, 2200, 2300A, 2300B according to the second embodiment described above can be applied to the optical microphone 1400 having the optical opening 107 in the diaphragm 101 illustrated in FIG. 25.

### [5.21 Effects of Second Embodiment]

The optical microphones 1400, 1500, 1600, 1700, 1800, 1900, 2000, 2100A, 2100B, 2100C, 2100D, 2200, 2300A, 2300B of the present disclosure have an effect of suppressing entry of the external light 114,116 into the light receiving element 103 inside the housing 105 to enable sound collection with a high SNR even in an environment with a large amount of the external light 114,116, and have an effect of improving safety and convenience of handling of the optical microphone by suppressing leakage of the light 104 of the light source 102 inside the housing 105 to the outside of the housing 105.

Note that the effects described in the second embodiment are merely examples and are not limited, and other effects may be provided.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the advantageous effects described in the present specification are merely illustrative or exemplary, and are not restrictive. That is, the technique according to the present disclosure can exhibit other advantageous effects obvious to those skilled in the art from the description of the present specification together with or instead of the above advantageous effects.

Note that the following configurations also belong to the technical scope of the present disclosure.

### (1)

An optical microphone comprising:
a housing;
a diaphragm provided in the housing;
a first light source provided within the housing;
a first light receiving element provided within the housing;
a detection unit that detects an output of the first light receiving element; and
a control unit that switches a control mode from a first control mode to a second control mode according to a determination result of an abnormal state by the detection unit.

### (2)

The optical microphone according to (1), wherein
the first control mode controls a sound output based on an output of the first light receiving element, and
the second control mode controls at least one of an output of the first light source or a sound output not based on an output of the first light receiving element.

### (3)

The optical microphone according to (1), further comprising a second light source different from the first light source within the housing.

### (4)

The optical microphone according to (3), wherein the first light source and the second light source are a laser or a light emitting diode.

### (5)

The optical microphone according to (3) or (4), wherein a wavelength range of the first light source does not overlap a wavelength range of visible light.

### (6)

The optical microphone according to any one of (3) to (5), wherein the second light source is visible light.

### (7)

The optical microphone according to any one of (3) to (6), wherein
the first control mode controls a sound output based on an output of the first light receiving element, and
the second control mode controls at least one of an output of the first light source, an output of the second light source, or a sound output not based on an output of the first light receiving element.

### (8)

The optical microphone according to any one of (3) to (7), wherein the second light source is turned on at least in the second control mode.

### (9)

The optical microphone according to any one of (1) to (8), wherein the first light receiving element includes at least a wavelength of visible light in a wavelength range of the first light receiving element.

### (10)

The optical microphone according to any one of (1) to (9), wherein the detection unit determines an abnormal state in a case where an output average of the first light receiving element is lower or higher than a predetermined range.

### (11)

The optical microphone according to any one of (1) to (8), further comprising a second light receiving element different from the first light receiving element, the second light receiving element being provided within the housing.

### (12)

The optical microphone according to (11), wherein a wavelength range of the second light receiving element includes at least a wavelength other than a wavelength range received by the first light receiving element.

### (13)

The optical microphone according to (11) or (12), wherein the detection unit detects at least one of an output average of the first light receiving element or an output average of the second light receiving element, and determines an abnormal state in a case where the output average of the first light receiving element or the output average of the second light receiving element is lower or higher than a predetermined range.

### (14)

The optical microphone according to any one of (1) to (13), further comprising a storage unit that stores switching of the control mode.

### (15)

An information processing apparatus comprising:
an optical microphone including a housing, a diaphragm provided in the housing, a first light source provided within the housing, a first light receiving element provided within the housing, a detection unit that detects an output of the first light receiving element, and a control unit that switches a control mode from a first control mode to a second control mode according to a determination result of an abnormal state by the detection unit; and
a system that performs an operation based on the control mode by the control unit.

### (16)

The information processing apparatus according to (15), wherein the system stops power supply to the optical microphone based on switching to the second control mode.

### (17)

The information processing apparatus according to (15) or (16), wherein the system includes a notification unit that performs notification based on switching to the second control mode.

### (18)

The information processing apparatus according to (17), wherein the notification unit performs an auditory notification.

### (19)

The information processing apparatus according to (17), wherein the notification unit performs a visual notification.

### (20)

An optical microphone comprising:
a housing;
a diaphragm provided in the housing;
a light source provided within the housing;
a light receiving element provided within the housing;
a partition that separates the diaphragm and at least the light receiving element;
a first opening provided in the housing or the diaphragm; and
a second opening provided in the partition,
wherein the second opening is disposed on a straight line with respect to a direction in which light from the light source arrives through the diaphragm, and
the first opening, the second opening, and the light receiving element are disposed out of a straight line.

### (21)

The optical microphone according to (20), wherein the light receiving element receives light from the light source that arrives via the diaphragm, and converts vibration information of the diaphragm into a sound output.

### (22)

The optical microphone according to (20) or (21), wherein the light receiving element includes a bandpass filter on a light receiving surface.

### (23)

The optical microphone according to any one of (20) to (22), wherein the first opening is a ventilation hole or a slit.

### (24)

The optical microphone according to any one of (20) to (23), wherein the first opening is disposed without the partition between the first opening and the diaphragm.

### (25)

The optical microphone according to any one of (20) to (24), wherein
the partition is configured of at least one of a first partition and a second partition,
the first partition is formed with a through hole forming the second opening, and
the second partition is formed of a light-transmissive member forming the second opening.

### (26)

The optical microphone according to (25), wherein in the second partition, the second opening is formed of at least one of glass, a bandpass filter, or an antireflection film.

### (27)

The optical microphone recited in (25), in which the second partition is formed with the second opening having a bandpass filter.

### (28)

The optical microphone recited in (25), in which the second partition is formed with the second opening having an antireflection film.

### (29)

The optical microphone recited in any one of (25) to (28), in which the second partition is provided to overlap with the first partition.

### (30)

The optical microphone recited in any one of (25) to (28), in which the second partition is formed such that the light-transmissive member is opaque except for the second opening.

### (31)

The optical microphone recited in any one of (25) to (28), in which in the second partition, the second opening of the first partition is filled with the light-transmissive member.

### REFERENCE SIGNS LIST

1, 2, 3 INFORMATION PROCESSING APPARATUS
100, 200, 300, 400, 500, 600, 700, 800, 900, 1000, 1100, 1200, 1300, 1400, 1500, 1600, 1700, 1800, 1900, 2000, 2100A, 2100B, 2100C, 2100D, 2200, 2300A, 2300B OPTICAL MICROPHONE
101 DIAPHRAGM
102 FIRST LIGHT SOURCE
103 FIRST LIGHT RECEIVING ELEMENT
105 HOUSING
106, 116, 126 FIRST OPENING
110, 510, 610, 710, 810, 910 PARTITION
110a FIRST PARTITION
110b SECOND PARTITION
110c FIRST PARTITION
110d SECOND PARTITION
110e FIRST PARTITION
110f SECOND PARTITION
111 SECOND OPENING
118 BANDPASS FILTER
119 BANDPASS FILTER
120 ANTIREFLECTION FILM
141 DETECTION UNIT
142 CONTROL UNIT
143 STORAGE UNIT
151, 152 NOTIFICATION UNIT
603 SECOND LIGHT RECEIVING ELEMENT
702 SECOND LIGHT SOURCE

1. An optical microphone comprising:
a housing;
a diaphragm provided in the housing;
a first light source provided within the housing;
a first light receiving element provided within the housing;
a detection unit that detects an output of the first light receiving element; and
a control unit that switches a control mode from a first control mode to a second control mode according to a determination result of an abnormal state by the detection unit.

2. The optical microphone according to claim 1, wherein
the first control mode controls a sound output based on an output of the first light receiving element, and
the second control mode controls at least one of an output of the first light source or a sound output not based on an output of the first light receiving element.

3. The optical microphone according to claim 1, further comprising a second light source different from the first light source within the housing.

4. The optical microphone according to claim 3, wherein the first light source and the second light source are a laser or a light emitting diode.

5. The optical microphone according to claim 3, wherein a wavelength range of the first light source does not overlap a wavelength range of visible light.

6. The optical microphone according to claim 3, wherein the second light source is visible light.

7. The optical microphone according to claim 3, wherein
the first control mode controls a sound output based on an output of the first light receiving element, and
the second control mode controls at least one of an output of the first light source, an output of the second light source, or a sound output not based on an output of the first light receiving element.

8. The optical microphone according to claim 3, wherein the second light source is turned on at least in the second control mode.

9. The optical microphone according to claim 1, wherein the first light receiving element includes at least a wavelength of visible light in a wavelength range of the first light receiving element.

10. The optical microphone according to claim 1, wherein the detection unit determines an abnormal state in a case where an output average of the first light receiving element is lower or higher than a predetermined range.

11. The optical microphone according to claim 1, further comprising a second light receiving element different from the first light receiving element, the second light receiving element being provided within the housing.

12. The optical microphone according to claim 11, wherein a wavelength range of the second light receiving element includes at least a wavelength other than a wavelength range received by the first light receiving element.

13. The optical microphone according to claim 11, wherein the detection unit detects at least one of an output average of the first light receiving element or an output average of the second light receiving element, and determines an abnormal state in a case where the output average of the first light receiving element or the output average of the second light receiving element is lower or higher than a predetermined range.

14. The optical microphone according to claim 1, further comprising a storage unit that stores switching of the control mode.

15. An information processing apparatus comprising:
an optical microphone including a housing, a diaphragm provided in the housing, a first light source provided within the housing, a first light receiving element provided within the housing, a detection unit that detects an output of the first light receiving element, and a control unit that switches a control mode from a first control mode to a second control mode according to a determination result of an abnormal state by the detection unit; and
a system that performs an operation based on the control mode by the control unit.

16. The information processing apparatus according to claim 15, wherein the system stops power supply to the optical microphone based on switching to the second control mode.

17. The information processing apparatus according to claim 15, wherein the system includes a notification unit that performs notification based on switching to the second control mode.

18. The information processing apparatus according to claim 17, wherein the notification unit includes at least one of an auditory notification or a visual notification.

19. An optical microphone comprising:
a housing;
a diaphragm provided in the housing;
a light source provided within the housing;
a light receiving element provided within the housing;
a partition that separates the diaphragm and at least the light receiving element;
a first opening provided in the housing or the diaphragm; and
a second opening provided in the partition,
wherein the second opening is disposed on a straight line with respect to a direction in which light from the light source arrives through the diaphragm, and
the first opening, the second opening, and the light receiving element are disposed out of a straight line.

20. The optical microphone according to claim 19, wherein the light receiving element receives light from the light source that arrives via the diaphragm, and converts vibration information of the diaphragm into a sound output.

21. The optical microphone according to claim 19, wherein the light receiving element includes a bandpass filter on a light receiving surface.

22. The optical microphone according to claim 19, wherein the first opening is a ventilation hole or a slit.

23. The optical microphone according to claim 19, wherein the first opening is disposed without the partition between the first opening and the diaphragm.

24. The optical microphone according to claim 19, wherein
the partition is configured of at least one of a first partition and a second partition,
the first partition is formed with a through hole forming the second opening, and
the second partition is formed of a light-transmissive member forming the second opening.

25. The optical microphone according to claim 24, wherein in the second partition, the second opening is formed of at least one of glass, a bandpass filter, or an antireflection film.
